(19) United States
(12) Patent Application Publication
(10) Pub. No.: US 2022/0309478 A1
(43) Pub. Date: Sep. 29, 2022

(54) OPTIMIZING EXECUTION OF TRANSACTION REQUESTS

(71) Applicant: APIFINY GROUP INC., New York, NY (US)

(72) Inventors: Maodong XU, New York, NY (US); Ashu SWAMI, New York, NY (US)

(21) Appl. No.: 17/596,893

(22) PCT Filed: Jun. 19, 2020
(86) PCT No.: PCT/IB2020/055760

§ 371 Date: Dec. 20, 2021

Related U.S. Application Data
(60) Provisional application No. 62/863,872, filed on Jun. 20, 2019.

(51) Int. Cl. G06Q 20/06; G06Q 20/02; G06Q 40/04; H04L 43/0864

(52) U.S. Cl. CPC G06Q 20/0652; G06Q 20/02; G06Q 40/04; H04L 43/0864; G06Q 2220/00

(57) ABSTRACT

A transaction processing system (110) configured to determine an optimized transaction router system (112) from a plurality of transaction router systems (112A-N). The system (110) is configured to retrieve a plurality of timing measurements, each being associated with one of the plurality of transaction router systems (112A-M) and one of a plurality of third party systems (130A-N). The system (110) is configured to determine a plurality of liquidity loss metrics based on the timing measurements, determine a plurality of effective remaining liquidity values based on the liquidity loss metrics, determine a total effective liquidity value of each transaction router system (112A-M) based on the effective remaining liquidity values, determine a plurality of order expiry metrics, determine a plurality of slippage metrics based on the order expiry metrics, and determine the optimized transaction router system (112) based at least in part on the total effective liquidity values and the slippage metrics.

### CROSS-REFERENCE TO RELATED APPLICATIONS

The present application claims priority from U.S. of America Provisional Patent Application No. 62/863,872 filed on 20 Jun. 2019, the contents of which are incorporated herein by reference in their entirety.

### TECHNICAL FIELD

Described embodiments relate to systems and computer-implemented methods for optimizing execution of transaction requests.

### BACKGROUND

In some networked systems, a third party system, for example, an asset exchange, may provide a list of open transactions. Each open transaction may represent an offer to buy or sell an asset controlled by a third party entity. This third party system may make the list of open transactions available to a client system via one or more data feeds. A client entity may, via the client system, send a transaction request to the third party system. The transaction request may comprise a request to execute one or more of the open transactions. Execution of one or more of the open transactions may transfer control of the asset from the third party entity to the client entity. This may be in exchange for a disposed asset controlled by the entity. That is, execution of one or more of the open transactions may transfer control of an acquired asset in exchange for the disposed asset.

Multiple third party systems may facilitate the exchange of the acquired asset and the disposed asset. These third party systems may be geographically distributed. For example, independent third party systems may be located in the North America, South America, Europe and the Asia Pacific Region (APAC). Each third party system may facilitate exchange of the asset in a local currency of the geographic region within which that third party system is located (for example, the local fiat currency). There is no mechanism to easily move assets or route transaction requests between the third party systems, in particular, those in different geographic regions.

Client entities wishing to use the third party systems are required to manage and operate an account on each individual third party system. In most cases this is infeasible at least in part because of local residency and bank account restrictions placed on entities that hold accounts with the relevant exchange.

A result of this is the third party systems tend to exist as isolated regional liquidity pools with crossed bids and offers with other third party systems. No automatic mechanism to address, or capitalize on the imbalances caused by the isolated regional liquidity pools exists.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer-implemented method of optimizing execution of a transaction request, the method comprising: retrieving a plurality of timing measurements; wherein each timing measurement is associated with one of a plurality of transaction router systems and one of a plurality of third party systems, the third party system being in communication with the respective transaction router system; wherein each timing measurement is indicative of a round trip time (RTT) between the transaction router system and the third party system that are associated with that timing measurement; and wherein each of the plurality of third party systems has an open transaction liquidity; determining a plurality of liquidity loss metrics, each liquidity loss metric corresponding to a respective timing measurement, and being associated with the transaction router system and the third party system that are associated with that timing measurement; wherein each liquidity loss metric is indicative of a proportion of the open transaction liquidity of the third party system associated with the liquidity loss metric that is unavailable to the transaction router system associated with the liquidity loss metric; determining a plurality of effective remaining liquidity values, each effective remaining liquidity value corresponding to a respective liquidity loss metric, and being associated with the transaction router system and the third party system that are associated with that liquidity loss metric; wherein each effective remaining liquidity value is indicative of a proportion of the open transaction liquidity of the third party system associated with the effective remaining liquidity value that is available to the transaction router system associated with effective remaining liquidity value; determining a total effective liquidity value of each transaction router system; wherein the total effective liquidity value of each transaction router system is determined by summing the effective remaining liquidity values associated with that transaction router system; determining a plurality of order expiry metrics, each order expiry metric being associated with one of the plurality of transaction router systems, and each order expiry metric being indicative of an average number of transaction requests sent from the relevant transaction router system that fail to execute because of a corresponding open transaction of one of the third party systems in communication with that transaction router system expiring within the relevant RTT; determining a plurality of slippage metrics, each slippage metric being based on one of the order expiry metrics and being associated with one of the plurality of transaction router systems; wherein each slippage metric is indicative of a probability that a transaction request sent from the relevant transaction router system will fail to execute because of a corresponding open transaction of one of the third party systems in communication with that transaction router system expiring within the relevant RTT; determining an optimized transaction router system that is one of the plurality of transaction router systems based at least in part on the total effective liquidity values and the slippage metrics; and sending a received transaction request to the optimized transaction router system, such that the optimized transaction router system can execute the transaction request via one or more of the third party systems, thereby optimizing execution of the transaction request.

In some embodiments, the method further comprises determining an effective liquidity proportion of each transaction router system; wherein each effective liquidity proportion is indicative of a ratio between the total effective liquidity value of the respective transaction router system and a total liquidity, the total liquidity being a sum of the open transaction liquidities of each third party system in communication with that transaction router system; and wherein determining the optimized transaction router system that is one of the plurality of transaction router systems is based at least in part on the effective liquidity proportions and the slippage metrics.

In some embodiments, a linear liquidity loss model relates each timing measurement to the corresponding liquidity loss metric.

In some embodiments, determining each of the plurality of effective remaining liquidity values comprises calculating the complement of one of the liquidity loss metrics.

In some embodiments, determining each effective liquidity proportion comprises dividing one of the total effective liquidity values by the total liquidity.

In some embodiments, the method further comprises storing an open transaction record history and/or an executed transaction record history.

In some embodiments, the plurality of order expiry metrics are determined based on an analysis of the open transaction record history and/or the executed transaction record history.

In some embodiments, determining each order expiry metric comprises: determining, for each third party system in communication with the relevant transaction router system, a number of transaction requests that fail to execute because of a corresponding open transaction of the relevant third party system expiring within the relevant RTT; and calculating an average of the numbers.

In some embodiments, determining each slippage metric comprises: modelling the slippage metrics according to a Poisson distribution, where a scale parameter (λ) of the Poisson distribution is the order expiry metric associated with the respective transaction router system.

In some embodiments, determining each slippage metric comprises: determining order expiry metrics for each of a number of order depths of each transaction router system such that each order depth is associated with a respective order expiry metric; modelling, for each order depth, a probability that a transaction request sent from the relevant transaction router system will fail to execute because of a corresponding open transaction of one of the third party systems in communication with that transaction router system expiring within the relevant RTT according to a Poisson distribution, where a scale parameter (λ) of the Poisson distribution is the order expiry metric associated with the respective transaction router system; and determining a probability model value (e^{-λ}) for each order depth.

In some embodiments, the method further comprises scaling each probability model value according to the order depth with which it corresponds.

In some embodiments, determining each slippage metric comprises summing probability model values corresponding to a respective transaction router system.

In some embodiments, order expiry metrics are determined for three order depths.

In some embodiments, determining the optimized transaction router system comprises determining the product of the total effective liquidity value and slipping metric associated with each respective transaction router system.

In some embodiments, the optimized transaction router system is the transaction router system which has the highest product.

In some embodiments, determining the optimized transaction router system comprises determining the average of the effective liquidity proportion and slipping metric associated with each respective transaction router system.

In some embodiments, the optimized transaction router system is the transaction router system that has the highest average.

In some embodiments, the method further comprises accessing an open transaction record store that comprises a combined list of a plurality of open transactions of the plurality of third party systems; dividing the received transaction request into one or more split transaction requests based on the open transaction record store; and sending each of the one or more split transaction requests to a corresponding one of the third party systems.

In some embodiments, the transaction request comprises a request to exchange a first unit count of a disposed asset for a second unit count of an acquired asset.

In some embodiments, the method further comprises: determining, based on the transaction request, the first unit count; exchanging, at a transaction processing system exchange, a user deposit for the first unit count of the disposed asset; dividing the first unit count of the disposed asset into two or more split unit counts of the disposed asset; and transferring control of each of the two or more split unit counts to a respective one of the third party systems, thereby capitalizing a transaction processing system account of each of those third party systems.

In some embodiments, the first asset is a stablefiat cryptocurrency pegged to a fiat currency.

Some embodiments relate to a computer-readable storage medium storing instructions that, when executed by a computer, cause the computer to perform the method of disclosed above.

Some embodiments relate to a transaction processing system configured to: retrieve a plurality of timing measurements; wherein each timing measurement is associated with one of a plurality of transaction router systems and one of a plurality of third party systems, the third party system being in communication with the respective transaction router system; wherein each timing measurement is indicative of a round trip time (RTT) between the transaction router system and the third party system that are associated with that timing measurement; and wherein each of the plurality of third party systems has an open transaction liquidity; determine a plurality of liquidity loss metrics, each liquidity loss metric corresponding to a respective timing measurement, and being associated with the transaction router system and the third party system that are associated with that timing measurement; wherein each liquidity loss metric is indicative of a proportion of the open transaction liquidity of the third party system associated with the liquidity loss metric that is unavailable to the transaction router system associated with the liquidity loss metric; determine a plurality of effective remaining liquidity values, each effective remaining liquidity value corresponding to a respective liquidity loss metric, and being associated with the transaction router system and the third party system that are associated with that liquidity loss metric; wherein each effective remaining liquidity value is indicative of a proportion of the open transaction liquidity of the third party system associated with the effective remaining liquidity value that is available to the transaction router system associated with effective remaining liquidity value; determine a total effective liquidity value of each transaction router system; wherein the total effective liquidity value of each transaction router system is determined by summing the effective remaining liquidity values associated with that transaction router system; determine a plurality of order expiry metrics, each order expiry metric being associated with one of the plurality of transaction router systems, and each order expiry metric being indicative of an average number of transaction requests sent from the relevant transaction router system that fail to execute because of a corresponding open transaction of one of the third party systems in communication with that transaction router system expiring within the relevant RTT; determine a plurality of slippage metrics, each slippage metric being based on one of the order expiry metrics and being associated with one of the plurality of transaction router systems; wherein each slippage metric is indicative of a probability that a transaction request sent from the relevant transaction router system will fail to execute because of a corresponding open transaction of one of the third party systems in communication with that transaction router system expiring within the relevant RTT; determine an optimized transaction router system that is one of the plurality of transaction router systems based at least in part on the total effective liquidity values and the slippage metrics; and send a received transaction request to the optimized transaction router system, such that the optimized transaction router system can execute the transaction request via one or more of the third party systems, thereby optimizing execution of the transaction request.

In some embodiments, the transaction processing system is further configured to: determine an effective liquidity proportion of each transaction router system; wherein each effective liquidity proportion is indicative of a ratio between the total effective liquidity value of the respective transaction router system and a total liquidity, the total liquidity being a sum of the open transaction liquidities of each third party system in communication with that transaction router system; and wherein determining the optimized transaction router system that is one of the plurality of transaction router systems is based at least in part on the effective liquidity proportions and the slippage metrics.

In some embodiments, one or more of retrieving the plurality of timing measurements, determining the plurality of liquidity loss metrics, determining the plurality of effective remaining liquidity values, determining the total effective liquidity value of each transaction router system, determining the plurality of order expiry metrics determining the plurality of slippage metrics and/or determining the optimized transaction router system is performed by a transaction routing optimizer of the transaction processing system.

In some embodiments, determining the effective liquidity proportion of each transaction router system is performed by a transaction routing optimizer of the transaction processing system.

In some embodiments, a linear liquidity loss model relates each timing measurement to the corresponding liquidity loss metric.

In some embodiments, determining each of the plurality of effective remaining liquidity values comprises calculating the complement of one of the liquidity loss metrics.

In some embodiments, determining each effective liquidity proportion comprises dividing one of the total effective liquidity values by the total liquidity.

In some embodiments, the transaction processing system is configured to store an open transaction record history and/or an executed transaction record history, wherein the plurality of order expiry metrics are determined based on an analysis of the open transaction record history and/or the executed transaction record history.

In some embodiments, determining each order expiry metric comprises: determining, for each third party system in communication with the relevant transaction router system, a number of transaction requests that fail to execute because of a corresponding open transaction of the relevant third party system expiring within the relevant RTT; and calculating an average of the numbers.

In some embodiments, determining each slippage metric comprises: modelling the slippage metrics according to a Poisson distribution, where a scale parameter (λ) of the Poisson distribution is the order expiry metric associated with the respective transaction router system.

In some embodiments, determining each slippage metric comprises: determining order expiry metrics for each of a number of order depths of each transaction router system such that each order depth is associated with a respective order expiry metric; modelling, for each order depth, a probability that a transaction request sent from the relevant transaction router system will fail to execute because of a corresponding open transaction of one of the third party systems in communication with that transaction router system expiring within the relevant RTT according to a Poisson distribution, where a scale parameter (λ) of the Poisson distribution is the order expiry metric associated with the respective transaction router system; and determining a probability model value (e^{-λ}) for each order depth.

In some embodiments, the transaction processing system is configured to scale each probability model value according to the order depth with which it corresponds.

In some embodiments, determining each slippage metric comprises summing probability model values corresponding to a respective transaction router system.

In some embodiments, the transaction processing system is configured to determine order expiry metrics for three order depths.

In some embodiments, determining the optimized transaction router system comprises determining the product of the total effective liquidity value and slipping metric associated with each respective transaction router system.

In some embodiments, the optimized transaction router system is the transaction router system which has the highest product.

In some embodiments determining the optimized transaction router system comprises determining the average of the effective liquidity proportion and slipping metric associated with each respective transaction router system.

In some embodiments, the optimized transaction router system is the transaction router system that has the highest average.

In some embodiments, the transaction processing system is further configured to access an open transaction record store that comprises a combined list of a plurality of open transactions of the plurality of third party systems; divide the received transaction request into one or more split transaction requests based on the open transaction record store; and send each of the one or more split transaction requests to a corresponding one of the third party systems.

In some embodiments, the transaction request comprises a request to exchange a first unit count of a disposed asset for a second unit count of an acquired asset.

In some embodiments, the transaction processing system is further configured to: determine, based on the transaction request, the first unit count; exchange, at a transaction processing system exchange, a user deposit for the first unit count of the disposed asset; and divide the first unit count of the disposed asset into two or more split unit counts of the disposed asset; and transfer control of each of the two or more split unit counts to a respective one of the third party systems, thereby capitalizing a transaction processing system account of each of those third party systems.

In some embodiments, the first asset is a stablefiat cryptocurrency pegged to a fiat currency.

### BRIEF DESCRIPTION OF DRAWINGS

Embodiments of the disclosure will now the described by way of example with reference to the accompanying drawings in which:

FIG. 1 is a block diagram of a system according to some embodiments;

FIG. 2 is a process flow diagram of a method of adjusting transaction distribution to optimize execution of a transaction request in accordance with some embodiments;

FIG. 3 is a block diagram of a system according to some embodiments;

FIG. 4 is a process flow diagram of a method for optimizing execution of a transaction request according to some embodiments;

FIG. 5 is a table illustrating example round trip time measurements between transaction router systems located in various geographical regions and third party systems located in various geographical regions;

FIG. 6 is a table illustrating example liquidity loss metrics for the transaction router system—third party system pairs of FIG. 5;

FIG. 7 is a table illustrating example total effective liquidity values and effective liquidity proportions of the transaction router systems (TRS) of FIGS. 5 and 6;

FIG. 8 is a table illustrating example order depths, weight factors, order expiry metrics, probability model values and slippage metrics of the transaction router systems of FIGS. 5 to 7;

FIG. 9 is a table illustrating example total effective liquidity values, effective liquidity proportions, slippage metrics and optimization metrics of the transaction router systems of FIGS. 5 to 8;

FIG. 10 is a process flow diagram of a method of recapitalizing account balances of the transaction processing system at each third party system according to some embodiments;

FIG. 11 is a block diagram of a number of regional third party systems of regional liquidity pools;

FIG. 12 is a block diagram illustrating a chain of transactions recorded on a blockchain that may be utilized in some embodiments;

FIG. 13 is a block diagram illustrating a connection of multiple blocks in a blockchain that may be utilized in some embodiments;

FIG. 14 is a block diagram illustrating an example computing device of some embodiments;

FIG. 15 is a block diagram illustrating a relationship between an optimized transaction router system, a transaction routing optimizer, a system data interface, a plurality of third party systems, and a transaction request of some embodiments;

### DESCRIPTION OF EMBODIMENTS

The figures and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Financial markets that facilitate the exchange of assets can be globally distributed. For example, third party systems (e.g. asset exchanges) that facilitate the exchange of assets may be located in a number of different geographical regions. Regions such as New York and London are financial centers that host a number of third party systems that facilitate the exchange of assets. These third party systems may be operated by a common entity, or may be operated by different entities. Trade of assets, for example, cryptocurrencies, is also facilitated by third party systems (i.e. cryptocurrency exchanges) that are located in a number of different geographical regions. Each third party system may facilitate exchange of the asset in a local currency of the geographic region within which that third party system is located (for example, the local fiat currency). There is no mechanism to easily move assets or route transaction requests between the third party systems, in particular, those in different geographic regions. This can result in the price of the asset being different between third party systems that are geographically distributed.

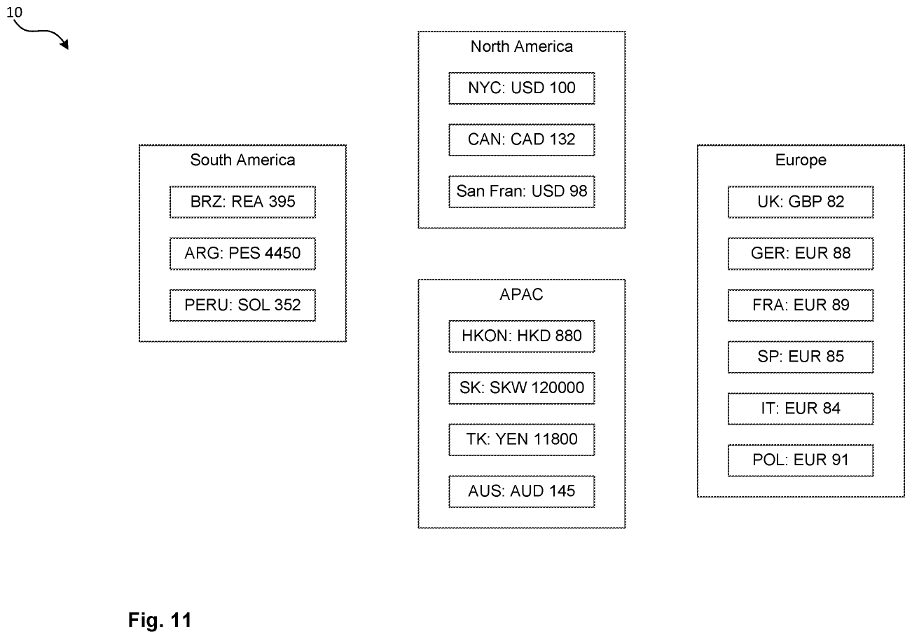

FIG. 11 shows an example of plurality of exchanges 10 for an asset. As shown in FIG. 11, the asset is valued differently on third party systems in different geographic regions. In particular, FIG. 11 illustrates a number of third party systems that facilitate the exchange of one unit of the asset (e.g. a stock of a company, a cryptocurrency). One unit of the asset is available for USD 100 at a North American third party system (NYC). This may be a New York City asset exchange (e.g. a stock exchange, cryptocurrency exchange etc.). One unit of the same, or an equivalent asset (e.g. another stock of the same company, another unit of the same cryptocurrency) is also exchangeable at a number of other third party systems in the North American region. For example, in FIG. 11, a North American region also includes a Canadian third party system (CAD) and a San Francisco third party system (San Fran), each facilitating trade of the asset. The asset is available for trade at the Canadian third party system in Canadian Dollars (CAD). The unit of the asset is available at different prices at the different exchanges, even within the North American region. This is typical of asset exchanges, because the movement of capital and assets across the exchanges is not unhindered. That is, even within one geographical region, there is no mechanism to easily move capital and assets between the third party systems.

FIG. 11 also shows examples of third party systems located in other geographic regions. These third party systems are located in different geographic regions including South America (SA), Europe (EP) and the Asia Pacific Region (APAC). Each region comprises third party systems that facilitate exchange of the asset in the local fiat currency. In South America, there are third party systems located in Brazil (BRZ), Argentina (ARG) and Peru (PERU), which facilitate trade in the Brazilian Real (REA), Argentinian Peso (PES) and Peruvian Sol (SOL) respectively. In the Asia Pacific Region, there are third party systems located in Hong Kong (HKON), South Korea (SK), Tokyo (TK) and Australia (AUS), which facilitate trade in the Hong Kong Dollar (HKD), South Korean Won (SKW), Japanese Yen (YEN) and Australian Dollar (AUD) respectively. In Europe (EP), there are third party systems located in the United Kingdom (UK), Germany (GER), France (FRA), Spain (SP), Italy (IT) and Poland (POL), which facilitate trade in the British Pound (GBP) and Euro (EUR).

Normalized best bids and offers in USD at these exchanges show a crossed market (resulting in a negative spread). If the movement of capital and assets was unhindered, arbitrageurs may take advantage of this, and the prices across the third party systems may equalize.

Hindering the movement of assets and capital between third party systems is therefore a barrier to optimizing transaction requests related to exchanging assets at these third party systems. Some embodiments of the disclosure are directed towards optimizing the execution of transaction requests accordingly.

### System Overview

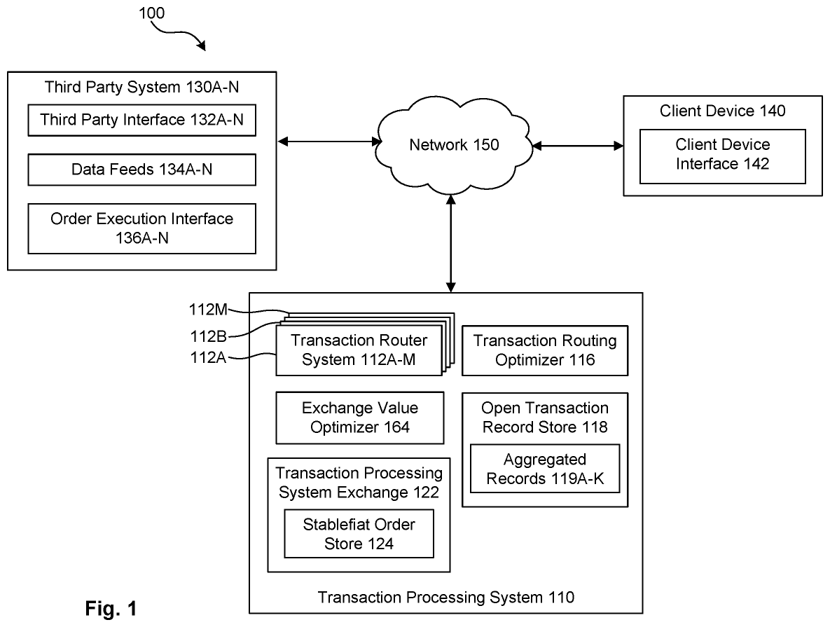

FIG. 1 illustrates an example system 100 to optimize execution of transaction requests, in accordance with an embodiment of the disclosure. The system 100 comprises a transaction processing system 110, as is described in more detail below.

### Third Party Systems 130A-N

The system 100 comprises a plurality of third party systems 130A-N. It will be appreciated that the system 100 may comprise any number of third party systems 130A-N, such that N is the total number of third party systems 130A-N.

The third party systems 130A-N each include one or more computing systems. The third party systems 130A-N each comprise one or more data feeds 134A-N. The third party systems 130A-N may make these data feeds 134A-N publically available, or available to a number of other parties. For example, the third party systems 130A-N may make these data feeds 134A-N available to the transaction processing system 110. In some embodiments, the third party systems 130A-N may provide the data feeds 134A-N to the transaction processing system 110. For example, the third party systems 130A-N may transmit the data feeds 134A-N to the transaction processing system 110. In some embodiments, one or more of the data feeds 134A-N may be in the form of a market gateway.

The data feeds 134A-N may include continuously updated information regarding a particular data source or data sources. That is, each data feed 134A-N may include continuously updated information related to its respective third party system 130A-N. The data sources may contain information regarding some of the elements being described in the respective data feed 134A-N. The data feeds 134A-N may therefore include continuously updated information regarding transactions (e.g., orders made in a financial market, purchase orders at a retail organization, logistics updates, shipping information), news (e.g., breaking news), predictions (e.g., weather reports), current statuses (e.g., status of equipment, public transportation, satellite positions), and so on. Each data feed 134 may be provided using various data formats, such as CSV (comma separated value), XML (extensible markup language), and so on. Each data feed 134A-N may be provided using a custom format, such as with an expanded character set or the use of binary characters, and the data within may be encrypted prior to transmission. The data feed 134A-N of a particular third party system 130A-N may differ from the data feed 134A-N of another third party system 130A-N. That is, the continuously updated information related to one third party system 130A-N may be different to that of another third party system 130A-N.

One or more of the data feeds 134A-N, may be made available in one or more updates. Each update may occur as data is generated, or may be generated periodically. For example, in the case of transactions, updates in the data feeds 134 include data entries that describe new open transactions, modifications to existing open transactions, executed transactions, and so on. Each update may have information about the data feed 134 itself (e.g., an identifier or symbol indicating the type of data the data feed 134 is presenting), as well as information about the element being described.

An open transaction of one of the third party systems 130A-N may comprise various parameters. For example, the open transaction may comprise a target, a value amount, a reported unit count, timestamp, and a transaction flow direction. The target may be an identifier of a particular asset such as a stock, bond, or cryptocurrency to which the open transaction is related. The value amount indicates a value amount for the target for that open transaction (i.e. a price that the target may be exchanged at). The reported unit count indicates a number of units of the target at that value amount. The timestamp indicates a time at which the open transaction was received by the transaction processing system 110. The transaction flow direction indicates a direction of the flow of the open transaction, whether ingress or egress. This may correspond to buy or sell, respectively.

Thus, in the case of open transactions, the corresponding data feed 134A-N entry may include information about the type of transaction, the target, the unit count, the value amount, the timestamp of transaction, and so on. By receiving the data feed updates, a recipient computing device may be able to determine a current state of the elements being described in the data feed 134A-N. For example, where the data feed 134A-N includes information about open transactions, the data feed 134A-N allows a system to determine a complete state of the open transactions described by the data feed 134A-N, i.e., to determine the current state of the market/exchange comprising these open transactions.

One or more of the third party systems 130A-N may optionally include a third party system interface 132A-N. Each third party interface 132A-N may allow computing systems external to the respective third party system 132A-N to access data, such as the data feeds 134A-N, that are generated and/or stored at the third party system 130A-N. Each third party system interface 132A-N may present standardized data access methods to external systems, such as via the use of an application programming interface (API), or other process. In some embodiments, the third party system interface 132A-N may provide a normalized API and messaging format for external systems (e.g. the transaction processing system 110 or components thereof). These standardized data access methods may also allow external systems, such as the transaction processing system 110, to authenticate with the third party systems 130A-N. The standardized data access methods may adhere to REST (representational state transfer) constraints.

In some embodiments, each third party system 130A-N may comprise multiple third party system interfaces 132A-N, with some being created for redundancy if the third party system interface 132A-N that is in use malfunctions or becomes otherwise unavailable.

One or more of the third party systems 130A-N may include an order execution interface 136A-N. In some embodiments, one or more of the third party interfaces 132A-N may comprise a respective order execution interface 136A-N. Each order execution interface 136A-N may allow computing systems external to the respective third party system 130A-N to send a transaction request to that third party system 130A-N. That is, each order execution interface 136A-N may allow the respective third party system 130A-N to receive transaction requests. Each order execution interface 136A-N may be in the form of an order execution gateway. In some embodiments, the order execution interfaces 136A-N may provide a normalized API and messaging format for external systems (e.g. the transaction processing system 110 or components thereof). The transaction requests may be received via a network 150. In some embodiments, each third party system 130A-N may comprise multiple order execution interface 136A-N, with some being created for redundancy if the order execution interface 136A-N that is in use malfunctions or becomes otherwise unavailable.

Each third party system 130A-N comprises an open transaction liquidity. Each third party system 130A-N comprises an open transaction liquidity for each target available on the respective third party system 130A-N. The open transaction liquidity of a third party system 130A-N is the sum of the value amounts of one of the targets of the third party system 130A-N. For example, where the target is Bitcoin (BTC), each third party system 130A-N comprises an open transaction liquidity corresponding to the value of the Bitcoin available in open transactions on that third party system 130A-N. This may be denominated in the target itself (e.g. 1000 BTC) or another denominator, for example, USD.

In some examples, one or more of the third party systems 130A-N are currency and/or cryptocurrency exchanges.

### Network 150

The elements of the system 100 may communicate via the network 150. The network 150 may be, for example, the Internet, a local area network, and so on. Some of the elements may communicate by one network, while other elements may communicate using a separate network. Each of these separate networks may be similar to the network 150. In one embodiment, the network 150 uses standard communications technologies and/or protocols. Thus, the network 150 can include links using technologies such as Ethernet, 702.11, direct microwave point to point connections, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 150 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 150 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the elements in the system 100 can use custom and/or dedicated data communications technologies instead of, or in addition to, the ones described above. For example, the network 150 may use a lean TCP/IP protocol that avoids a TCP/IP handshake penalty between elements to reduce communications latency.

### Client Device 140

The system 100 also comprises a client device 140. The client device 140 may be operated by a user and be used by the user as a front-end device with which the user may be able to access data generated by the transaction processing system 110, and to submit requests to the transaction processing system 110. For example, the client device 140 may be able to present to the user a list of open transactions, and to allow the user to submit requests to execute transactions. Examples of suitable client devices 140 include personal computers (PC), desktop computers, laptop computers, tablet computers, smartphones, wearable electronic devices such as smartwatches, or another suitable electronic device.

The client device 140 may include a client device interface 142. The client device interface 142 may be provided by the transaction processing system 110 (e.g., the transaction router system 112A-M) or by computer-readable instructions executed by the client device 140. The user may be able to access data or available at the transaction processing system 110 via the client device interface 142. In addition, the user may also be able to submit transaction requests via the client device interface 142. The client device interface 142 may take different forms. In one embodiment, the client device interface 142 is a component of a software application, which may be provided by the transaction processing system 110 or an operator of the transaction processing system 110. For example, the software application may provide a front-end user interface that can be provided at the client device 140. The software application may be a package of computer-executable code that can be acquired (e.g., downloaded) and installed or executed at a client device 140. In another embodiment, the client device interface 142 may be an interface provided directly via the transaction processing system 110 or other server. For example, the client device interface 142 may be one or more web pages. The client device interface 142 may include a graphical user interface (GUI) that displays various information and graphical elements. In another embodiment, the client device interface 142 may not include graphical elements but may communicate with the transaction processing system 110 via other suitable ways such as application program interfaces (APIs).

### Transaction Processing System 110

As previously mentioned, the system 100 comprises the transaction processing system 110. The transaction processing system 110 is configured to facilitate the execution of transaction requests provided to the transaction processing system 110. A transaction request may comprise various parameters. For example, the transaction request may comprise a target, a value amount, a reported unit count, timestamp, and/or a transaction flow direction. The target may be an identifier of a particular asset such as a stock, bond, or cryptocurrency to which the transaction request is related. The value amount indicates a value amount for the target for that transaction request. The reported unit count indicates a number of units of the target at that value amount. The timestamp indicates a time at which the transaction request was received by the transaction processing system 110. The transaction flow direction indicates a direction of the flow of the transaction, whether ingress or egress. This may correspond to buy or sell, respectively.

### Open Transaction Record Store 118

The transaction processing system 110 comprises at least one open transaction record store 118. The transaction processing system 110 is configured to retrieve the information available from each data feed 134A-N of the third party systems 130A-N. The transaction processing system 110 processes the information retrieved from the data feeds 134A-N of the third party systems 130A-N and stores this information locally in one or more aggregated records 119A-K of the open transaction record store 118. In some embodiments, each aggregated record 119A-K stores all information from all data feeds 134A-N for a single target. This target is an indicator to which some or all data in that aggregated record 119A-K is related to, and may be indicated in the updates received from the data feeds 134A-N. For example, a target may be an identifier of a particular asset such as a stock, bond, or cryptocurrency.

The open transaction record store 118 includes information from the multiple data feeds 134A-N of all third party systems 130A-N from which the transaction processing system 110 retrieves information. The transaction processing system 100 also processes updates to the data feeds 134A-N of the third party systems 130A-N and stores these updates locally. That is, the transaction processing system 100 updates the open transaction record store 118 in accordance with updates to the data feeds 134A-N. As such, the open transaction record store 118 comprises up-to-date aggregated records 119A-K.

In particular, the open transaction record store 118 keeps a local version of the data feeds 134A-N based on the data entries retrieved from the data feeds 134A-N. These data entries may indicate new open transactions that have been created, modifications to existing open transactions, or open transactions that have been executed on the relevant third party system 130A-N. Such an open transaction is a transaction that can be executed upon request by a user or other entity. Upon retrieving the updates from the data feeds 134A-N, the transaction processing system 110 updates a list of open transactions stored in the open transaction record store 118. That is, the transaction processing system 110 updates the relevant aggregate record 119A-K in accordance with the updated data entries.

Each entry in the open transaction record store 118 (i.e. each entry of each aggregate record 119A-K), which indicates an open transaction, may further include a value amount, a reported unit count, timestamp, and a transaction flow direction. The value amount indicates a value amount for the target for that open transaction data entry. The reported unit count indicates a number of units of the target at that value amount. The timestamp indicates a time at which the open transaction was received by the third party system 130A-N which provided the data feed 134A-N from which the information for the open transaction was retrieved. The transaction flow direction indicates a direction of the flow of the transaction, whether ingress or egress. This may correspond to buy or sell, respectively. Thus, one entry in the open transaction record store 118 for a target “B” may indicate a value amount of “1000” with a reported unit count of “5,” with a transaction flow direction of ingress. This may correspond to an open transaction available for execution to acquire 5 units of the target B at the value amount of 1000. In such a case, a user of one of the third party systems 130A-N may, via a transaction request, request execution of this open transaction. Upon execution, the user may transfer 5 units of the item indicated by the target to a user who dispatched this particular open transaction to one of the third party systems 130A-N. In exchange, the user receives a value amount of 5000 for this transaction. If the transaction flow direction is egress, then execution of the open transaction would instead cause the user to receive the 5 units of the target “B,” at a value amount of 1000 each. The user would have to transfer a value amount of 5000 to the external user which submitted the open transaction. In some embodiments, the user of the third party systems 130A-N is the transaction processing system 110.

The open transaction entries in the open transaction record store 118 may further be ordered based on one or more parameters. In one embodiment, the open transactions are ranked according to the value amount indicated in the open transaction. For open transactions with an egress transaction flow direction, the open transactions with the lowest value amount may be ranked first. For open transactions with ingress transaction flow directions, the open transactions with the highest value amount may be ranked first. If two open transactions have the same value amount, they may further be ranked according to timestamp, with the oldest timestamp open transactions being ranked highest.

In some cases, the transaction processing system 110 may retrieve a data entry from the data feeds 134A-N indicating a modification of an existing open transaction of the open transaction record store 118. Alternatively, the relevant third party system 130A-N may provide this data to the transaction processing system 110. In such a case, the transaction processing system 110 may modify the existing open transaction according to the instructions in the data feed entry. The modification may include modifications to any of the values in the open transaction stored in the open transaction record store 118, such as the value amount, reported unit count, and so on. The data entry received from the data feeds 134A-N may also indicate that a transaction is executed (i.e., filled). In such a case, the transaction processing system 110 may remove the open transaction entry from the aggregated record 119A-K (open transaction record store 118).

Thus, the open transaction record store 118 stores one or more aggregated records 119A-K, with each aggregated record 119A-K storing open transactions regarding a particular target, and with each aggregated record 119A-K storing open transactions retrieved from data feeds 134A-N of multiple third party systems 130A-N. The open transaction record store 118 may be stored in a shared memory space that may be accessed by other components of the transaction processing system 110.

### Open Transaction Record History Store

In some embodiments, the transaction processing system 110 comprises an open transaction record history store (no shown). The open transaction record history store stores historical versions of the open transaction record store 118. The open transaction record history store may store new copies, i.e., new historical open transaction records, of the open transaction record store 118 for every change made to the open transaction record store 118. Alternatively, the open transaction record history store may store new historical open transaction records, of the open transaction record store 118 periodically according to a schedule (e.g., once per second). In one embodiment, at least one historical open transaction record is created every hour. The historical open transaction records may be stored as differential copies, i.e., only the changes from the previous copy are stored with each new copy. The open transaction record history store may be stored in a disk-based database. Each historical open transaction record may have a unique identifier, timestamp, and other metadata, such as a transaction target of the copy, number of changes in the copy compared to the previous copy, and so on.

### Executed Transaction History Store

In some embodiments, the transaction processing system 110 comprises an executed transaction record history store (not shown). The executed transaction record history store stores executed transaction records which are transactions that have been requested to be executed by users, such as the users of the client devices 140, and subsequently executed. These executed transactions are open transactions listed in the open transaction record store 118 that have been requested for execution. The transaction may be directly requested by the user, or via a routing system, such as one of the transaction router systems 112A-M, which route a transaction request from a user to a respective third party system 130A-N to execute one or more open transactions. Once executed, the transaction indicated in the open transaction occurs, according to the parameters indicated in the open transaction (e.g., value amount, reported unit count, transaction flow direction, target) as noted above. The transaction may involve two entities, one of which may be the user of a client device 140, which connects to the transaction processing system 110.

Each executed transaction record includes information regarding an open transaction which was executed, either by storing a copy of the open transaction or a reference to the open transaction, e.g., a reference to the open transaction stored in the open transaction record history store. In addition, the executed transaction record history store stores, for each executed transaction record, an executed unit count. The executed unit count is the actual number of units that were executed in the transaction, and may differ from the reported unit count indicated in the open transaction. Each executed transaction record also stores the requested unit count, which corresponds to the number of units that were requested when executing the open transaction. The requested unit count for an open transaction can be less than or equal to the reported unit count for that open transaction, and indicates a desired number of units for which a user or other entity wishes to transact from those available in the open transaction (as indicated by the reported unit count).

### Adjusted Transaction Record Store

In some embodiments, the transaction processing system 100 comprises an adjusted transaction record store. The adjusted transaction record store may be generated based on the executed transaction record history store and the open transaction record history store. In some embodiments, the adjusted transaction record store is generated by the transaction processing system 110, as described in International Patent Application No. PCT/IB2020/051578, and U.S. patent application Ser. No. 16/508,192 the contents of both of which are incorporated herein by reference in their entirety. For example, the adjusted transaction record store may be generated by a transaction analyzer as described in International Patent Application No. PCT/IB2020/051578 or U.S. patent application Ser. No. 16/508,192.

### Transaction Router Systems 112A-M

The transaction processing system 110 comprises one or more transaction router systems 112A-M. For example, the transaction processing system 110 may include a first transaction router system 112A and a second transaction router system 112B. It will be appreciated however, that the system 100 may comprise any number of transaction router systems 112A-M, such that M is the total number of transaction router systems 112A-M.

Each transaction router system 112A-M is in communication with a number of the third party systems 130A-N over the network 150. In some embodiments, each transaction router system 112A-M is in communication with each third party system 130A-N. In some embodiments, each transaction router system 112A-M is in communication with a sub-set of the third party systems 130A-N. For example, the transaction router systems 112A-M of a particular geographical region may be in communication only with the third party systems 130A-N that are also located in that geographical region.

For the purposes of this disclosure, being located in a particular geographical region is intended to include at least being physically located in the respective region, or appearing to be physically located in the respective region. This interpretation may be relevant for each feature of the disclosure. For example, one of the third party systems 130A-N may be taken to be located in a respective geographical region if the computing hardware associated with that third party system 130A-N is physically located in that geographical region. Furthermore, one of the third party systems 130A-N may be taken to be located in a respective geographical region if it appears, to others on communicating with it (e.g. over the network 150), to be located in that geographical region. For example, if an IP address of the respective third party system 130A-N indicates that that third party system 130A-N is located in the respective geographical region, that third party system 130A-N is considered to be located in the respective geographical region, even if the computing hardware associated with that third party system 130A-N is not physically located in that geographical region.

Each transaction router system 112A-M may be located in a respective geographical region. The geographical regions may be defined such that only a single transaction router system 112A-M is located in a particular geographical region. For example, the geographical regions may be defined to correspond generally with North America, South America, Europe/Africa and the Asia Pacific Region. Europe/Africa may combine Europe and Africa into one geographic region. There may be four transaction router systems 112A-D, with one transaction router system 112A-D being located in each of the four geographical regions. Each of the geographical regions may comprise one or more third party systems 130A-N as previously disclosed. Each transaction router system 112A-D may be in communication with only the third party systems 130A-N that are located in the geographical region of the transaction router system 112A-D.

Each transaction router system 112A-M of the transaction processing system 110 is configured to route transaction requests to one or more of the third party systems 130A-N to execute one or more open transactions. In particular, each transaction router system 112A-M is configured to route requests to execute open transactions listed at the open transaction record store 118 or the adjusted transaction record store (if present) to the third party systems 130A-N such that the open transactions that are selected for execution are optimally selected and distributed amongst the various third party systems 130A-N.

In some embodiments, one or more of the transaction router systems 112A-M comprises the (or a copy of the) open transaction record store 118, aggregated records 119A-K, open transaction record history store, executed transaction record history store and/or adjusted transaction record store. In some embodiments, each of the transaction router systems 112A-M comprises the (or a copy of the) open transaction record store 118, aggregated records 119A-K, open transaction record history store, executed transaction record history store and/or adjusted transaction record store.

### Technical Problems

There are a number of technical problems associated with routing transaction requests to one or more of the third party systems 130A-N to execute one or more open transactions. Communication between the transaction processing system 110 and each of the third party systems 130A-N is not instantaneous. That is, there is a latency associated with communications between one or more components of the transaction processing system 110 and one of the third party systems 130A-N over the network 150. This latency is a round trip time (RTT) of a signal between the relevant transaction router system 112A-M and third party system 130A-N. That is, the latency is a measure of a length of time taken for one component of the system 100 to send a signal to another component of the system 100, and to receive an acknowledgement of that signal from the component to which it was sent. For example, each one of the transaction router systems 112A-M will have a respective latency with each one of the third party systems 130A-N with which it is in communication over the network 150. This latency is indicative of the time taken for a signal sent from the transaction router system 112A-M to the third party system 130A-N to be received by the third party system 130A-N, and for an acknowledgement sent from the third party system 130A-N to the transaction router system 112A-M to be received by the transaction router system 112A-M (i.e. the RTT of a signal between the relevant transaction router system 112A-M and third party system 130A-N). The latency for Internet communication between major market centers can be significant. For example, the latency of internet communication between Hong Kong and New York can exceed 300 ms.

Another technical problem associated with routing transaction requests to one or more of the third party systems 130A-N to execute one or more open transactions is related to the lifespan of the open transactions. A significant portion of the open transactions of the third party systems 130A-N have a relatively short lifespan. For example, the lifespan of a significant portion of the open transactions can be less than 5 seconds. The latencies between the transaction router systems 112A-M and the third party systems 130A-N can lead to the transaction router systems 112A-M routing transaction requests based on stale information. That is, one or more of the open transactions that a transaction router system 112A-M routes transaction requests based on may be cancelled within a time period comparable to the latency between the transaction router system 112A-M and the relevant third party system 130A-N. This can result in a failure of the transaction request to execute, or execution of the transaction request at worse than expected price. Execution of a transaction request at a worse than expected price can be referred to as a slippage. This can also result in race conditions with other entities wishing to execute open transactions available at the relevant third party system 130A-N.

### Method of Adjusting Transaction Distribution to Optimize Execution of a Transaction Request

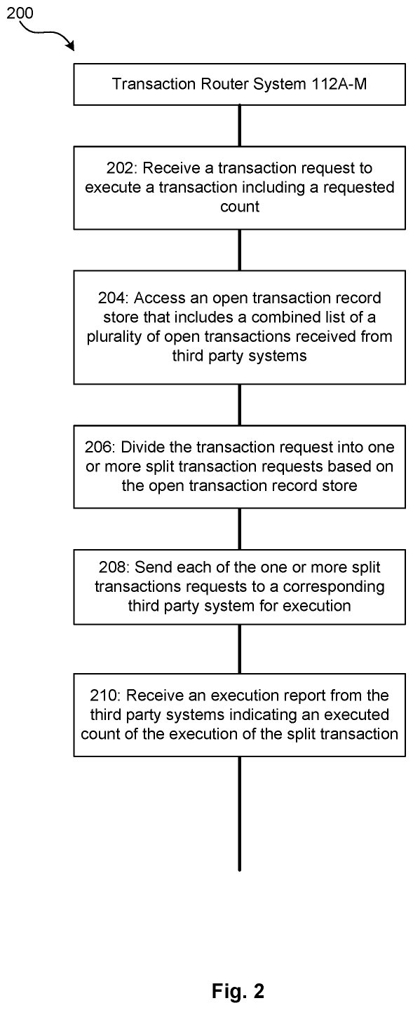

Each transaction router system 112A-M of the present disclosure may refer to the open transaction record store 118, and attempt to route transaction requests to one or more of the third party systems 130A-N based on the open transaction record store 118. FIG. 2 is a flowchart illustrating an example method 200 of adjusting transaction distribution to optimize execution of a transaction request in accordance with an embodiment. In one embodiment, the illustrated operations are executed by the transaction processing system 110. In particular, the illustrated method 200 is performed by at least one of the transaction router systems 112A-M. The method 200 may be performed by an optimized transaction router system described in more detail below.

At 202, the transaction router system 112A-M receives a transaction request to execute a transaction including a requested count. The transaction request may be received by the transaction processing system 110, and provided to the transaction router system 112A-M. This may be a request from a client device 140 and may be an aggregate request. The requested count may comprise a value amount as previously described. The requested count may comprise an ingress or egress direction as previously described. In some embodiments, one or more of the transaction router systems 112A-M receives the transaction request directly (e.g. from the client device 140). That transaction router system 112A-M may share the transaction request with one or more of the other transaction router systems 112A-M (e.g. via the network 150). The transaction request causes the transaction router system 112A-M to initiate execution one or more open transactions as described above with various third party systems 130A-N.

At 204, the transaction router system 112A-M accesses the open transaction record store 118 that includes a combined list of a plurality of open transactions received from third party systems 130A-N as previously described. In some embodiments, the transaction router system 112A-M stores a local copy of the open transaction record store 118 and accesses this open transaction record store 118. In other embodiments, another component of the transaction processing system 110 stores the open transaction record store 118, which is accessed by the transaction router system 112A-M. In some embodiments, the transaction router system 112A-M accesses an adjusted transactions list of the open transaction record store 118. Each open transaction comprises a requested unit count for each open transaction. The transaction count may comprise a value amount and/or an ingress or egress direction as previously.

At 206, the transaction router system 112A-M divides received transaction request into one or more split transaction requests based on the open transaction record store 118. The one or more split transactions are transactions that are routed by the transaction router system 112A-M to the relevant third party systems 130A-N. Each requested unit count for each split transaction would have a requested unit count for an open transaction at a third party system 130A-N that is less than or equal to the adjusted unit count for that open transaction.

At 208, the transaction router system 112A-M sends each of the one or more split transactions requests to a corresponding third party system 130A-N for execution. After execution, each third party system 130A-N responds with the results of the execution. The transaction router system 112A-M may send each split transaction request as an independent transaction request to the relevant third party system 130A-N targeting individual open transactions reported by the third party system 130A-N via its data feed 134A-N. Alternatively, in at least one embodiment, the transaction request may be transmitted as a single aggregate request to the third party system 130A-N, rather than targeting individual open transactions reported by the third party system 130A-N via its data feed 134A-N. In this case, the single aggregate request may have various parameters, including an aggregate requested unit count (i.e., a total unit count requested for execution in the aggregate request), as well as a value amount (and transaction flow direction). The third party system may then execute this request by executing open transactions which match the request until the executed unit count for all the executed transactions matches the requested unit count in the request.

At 210, the transaction router system 112A-M receives an execution report from the each of the third party systems 130A-N involved in execution of the transaction request, indicating an executed count of the execution of the split transaction. The execution count may comprise count a value amount and/or an ingress or egress direction of the open transaction(s) executed.

### Order Routing Module 116

The transaction processing system 100 also comprises an order routing module 116. The order routing module 116 is configured to determine an optimized transaction router system 112A-M, as is described in more detail below. In some embodiments, the order routing module 116 is configured to determine an optimized transaction router system 112A-M as described with reference to the computer-implemented method 400. In some embodiments, each transaction router system 112A-M may comprise a respective order routing module 116. In these embodiments, the order routing module 116 of each transaction router system 112A-M may perform the method 400 as described below. In some embodiments, each order routing module 116 arrives at the same outcome when performing the method 400, and thus, each is aware of the optimized transaction router system 112A-M that is authorized to send the transaction requests to the third party systems 130A-N.

### Transaction Processing System Exchange 122

The transaction processing system 100 also comprises a transaction processing system exchange 122. As previously described, client entities that wish to transact across a plurality of third party systems are typically required to manage and operate an account on each individual third party system. This can be infeasible at least in part because of local residency and bank account restrictions placed on entities that hold accounts with the relevant exchange.

As the system 100 comprises the transaction processing system exchange 122, users of the transaction processing system 100 are not required to manage and operate an account on each individual third party system to gain the advantage of the liquidity provided by those systems. Instead, the operator of the transaction processing system 100 that comprises the transaction processing system exchange 122 can maintain an account at each third party system 130A-N. The operator of the transaction processing system 100 can also maintain a balance in each third party system 130A-N. The operator of the transaction processing system 100 may, for example, have one or more accounts at each third party system 130A-N. The operator of the transaction processing system 100 may maintain a balance of one or more assets in each of these accounts. The maintained balances can provide the capital to allow the transaction processing system 100 to execute the transaction requests as herein described. The maintained balances can be in the local fiat currency, or in an instrument tied to the value of the local fiat currency.

In some embodiments, one or more of the third party systems 130A-N allow deposits to be made in cryptocurrencies. In particular, in some embodiments, one or more of the third party systems 130A-N allow deposits to be made in one or more stablefiat cryptocurrencies. A stablefiat cryptocurrency is a cryptocurrency designed with a view of minimizing volatility of the price of the stablefiat cryptocurrency relative to a fiat currency. A stablefiat cryptocurrency may be considered to be a digital representation of value, and blockchain technology may be used, as described herein, to allow control of currency units of the stablefiat cryptocurrency to be transferred between entities. The value of one unit of a stablefiat cryptocurrency may be pegged to the value of a government-issued fiat currency. For example, one unit of a stablefiat cryptocurrency may be pegged to the value of one United States Dollar. Such a stablefiat cryptocurrency may allow control of units of the stablefiat cryptocurrency to be transferred between entities, and therefore, may allow the transfer of value of an equivalent quantity of United States Dollars to be transferred. In some embodiments, units of a stablefiat cryptocurrency are redeemable for the underlying asset. Thus, in the previous case where the stablefiat cryptocurrency was pegged to the value of the USD, each unit may be redeemable for $1 USD. Stablefiat cryptocurrencies can be pegged to one of a number of currencies, for example, the USD (USDD stablefiat cryptocurrency), the Great British Pound (GPBD stablefiat cryptocurrency) or the Korean Won (KRWD stablefiat cryptocurrency). Because of the nature of blockchain technology, as described in more detail below, these stablefiat cryptocurrencies can be sent from a blockchain address anywhere in the world, to another blockchain address anywhere else in the world, virtually instantly. In some embodiments, one or more stablefiat currency may be referred to as a stablecoin.

The transaction processing system exchange 122 may be a stablefiat exchange that facilitates the exchange of stablefiat cryptocurrencies, as is described in further detail below. In particular, the transaction processing system exchange 122 may facilitate the exchange of fiat currencies for stablefiat cryptocurrencies that are pegged to the respective fiat currency. The stablefiat cryptocurrencies may be redeemable for the fiat currency at transaction processing system exchange 122.

The transaction processing system exchange 122 comprises a stablefiat cryptocurrency order store 124. The stablefiat cryptocurrency order store 124 comprises a plurality of open transactions that facilitate the exchange of fiat currencies for a respective stablefiat cryptocurrency, and stablefiat cryptocurrencies for a respective fiat currency. The users of the transaction processing system 100 can therefore exchange their local fiat currency for one or more stablefiat cryptocurrencies that are pegged to, and redeemable for one or more local fiat currencies at the transaction processing system exchange 122.

In some embodiments, the user of the transaction processing system 110 can deposit capital (e.g. a fiat currency, a cryptocurrency etc.) to an account of the transaction processing system 110, and the transaction processing system 110 can use the deposit to provide the necessary funds to execute a transaction request as herein disclosed.

The transaction processing system exchange 122 is configured to communicate with each of the third party systems 130A-N. In particular, the transaction processing system exchange 122 is configured to transfer one or more assets from the control of the transaction processing system exchange 122 to the control of each of the third party systems 130A-N. In some embodiments, the transaction processing system exchange 122 is configured to transfer one or more assets from a user account of the transaction processing system 110 (which may be an account on the transaction processing system exchange 122) to one or more transaction processing system accounts on the third party systems 130A-N. The transaction processing system accounts may be drawn from when executing transaction requests on the respective third party system 130A-N.

Although described as a component of the transaction processing system 110, it will be appreciated that in some embodiments, the transaction processing system exchange 122 may be independent of the transaction processing system 110. That is, the operator of the transaction processing system 110 may differ from the operator of the transaction processing system exchange 122. In such cases, the transaction processing system 110 may communicate with the transaction processing system exchange 122 via the network 150 to perform the functionality described herein.

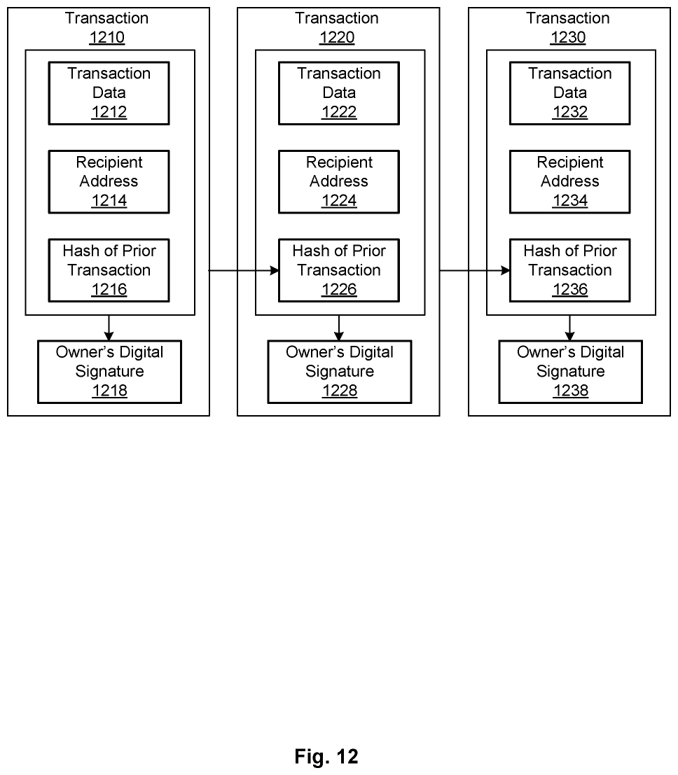

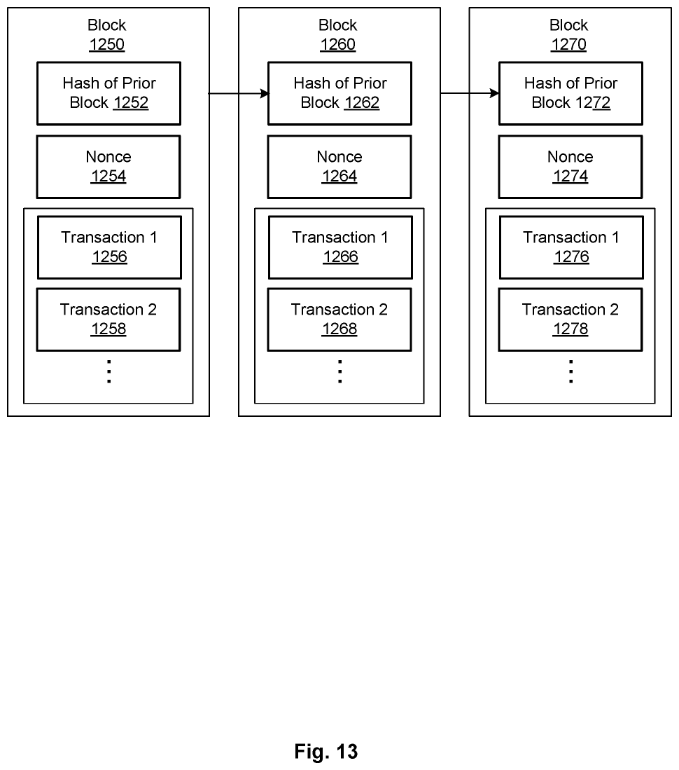

The system 100 may therefore also optionally include one or more blockchains (not shown) which can be accessed by elements on the network 150 to record the executed transactions on one or more blockchains. For example, the data feeds 130A-N may include data about exchange rates between various cryptocurrencies which have transaction ledgers recorded on various blockchains. The client device 140, by accessing the transaction processing system 110 to request execution of open transactions, may be able to see information regarding all the data feeds 134A-N, and thus the exchange rates of these cryptocurrencies. The client device 140, by accessing the transaction processing system 110 to request execution of open transactions, may be able to see information regarding all the open orders associated with the conversion of their local fiat currency to one or more stablefiat cryptocurrencies via the transaction processing system exchange 122. Subsequently a user may be able to use the client device 140 to request execution of these open transactions to exchange these various cryptocurrencies. Upon completion of a transaction, the third party system 130A-N, transaction processing system 110, or some other entity may submit transactions to the corresponding blockchains to effect the completion of the transaction by recording them to the respective blockchain ledgers. The blockchains may be public blockchains. A public blockchain network may include a plurality of nodes that cooperate to verify transactions and generate new blocks (which may record transaction information regarding cryptocurrencies). In some implementations of a blockchain, the generation of a new block may also be referred to as a mining process. The blockchains may support smart contracts, which are set of code instructions that are executable when one or more conditions are met. When triggered, the set of code instructions may be executed by a computer such as a virtual machine of the blockchain. Here, a computer may be a single operation unit in a conventional sense (e.g., a single personal computer) or may be a set of distributed computing devices that cooperate to execute the code instructions (e.g., a virtual machine or a distributed computing system). Examples of such public blockchain platforms include Bitcoin, Ethereum, EOS, NEO, Cardano, Stellar, etc. In some embodiments, a private blockchain may be employed. For example, one or more stablefiat currencies may be transacted over a private blockchain. Additional details regarding the properties of the blockchain are described below with reference to FIGS. 12 and 13.

The transaction processing system 110 comprises an exchange value optimizer 164. The exchange value optimizer 164 is configured to execute a computer-implemented method 1000, as is described in more detail below. In particular, the exchange value optimizer 164 is configured to facilitate the capitalization or recapitalization of transaction processing system accounts on the third party systems 130A-N involved in the execution of a transaction request using the transaction processing system exchange 122.

### Further Example of a Transaction Processing System

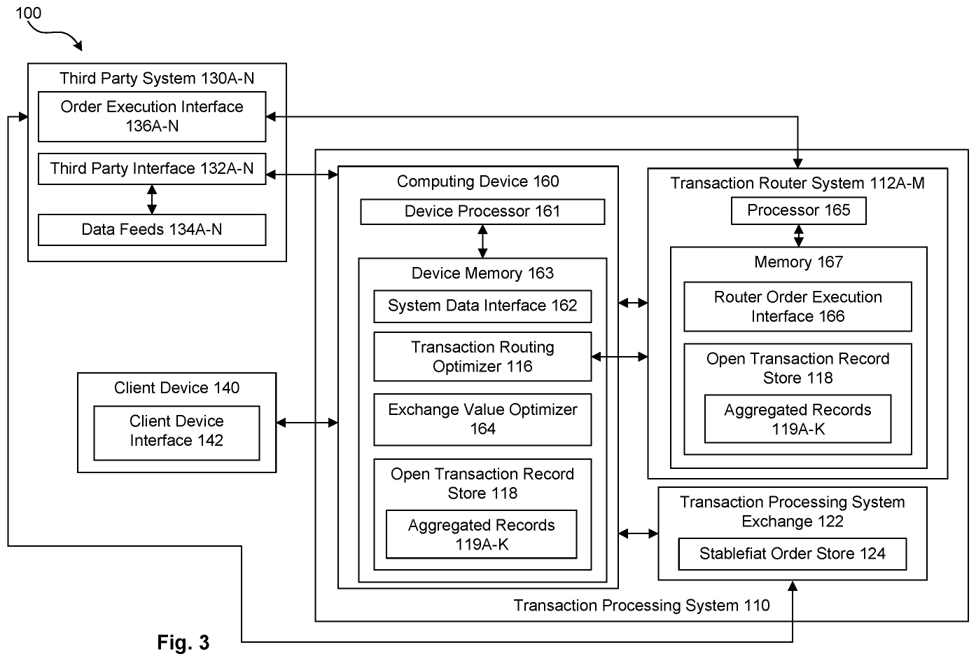

FIG. 3 illustrates an example embodiment of the system 100 and transaction processing system 110 described with reference to FIG. 1. The transaction processing system 110 comprises a computing device 160. Although described with reference to the transaction processing system 110 of FIG. 3, it will be appreciated that the transaction processing system 110 of FIG. 1 may comprise the computing device 160. The computing device 160 comprises a device processor 161 and a device memory 163.

The device processor 161 is configured to execute instructions stored in the device memory 163 to cause the computing device 160 to function according to the described methods. In some embodiments, the instructions are in the form of instruction program code. The device processor 161 may comprise one or more microprocessors, central processing units (CPUs), application specific instruction set processors (ASIPs), application specific integrated circuits (ASICs) or other processors capable of reading and executing instruction code.

The device memory 163 may comprise one or more volatile or non-volatile memory types. For example, the device memory 163 may comprise one or more of random access memory (RAM), read-only memory (ROM), electrically erasable programmable read-only memory (EEPROM) or flash memory. The device memory 163 is configured to store program code accessible by the device processor 161. The program code comprises executable program code modules. In other words, the device memory 163 is configured to store executable code modules configured to be executable by the device processor 161. The executable code modules, when executed by the device processor 161 cause the computing device 160 to perform certain functionality, as described in more detail below.

In the illustrated embodiment, the transaction routing optimizer 116 is an executable code module stored in device memory 163. It will be appreciated however, that in other embodiments, the transaction routing optimizer 116 may be a stand-alone computing device.

In the illustrated embodiment, the computing device 160 is in communication with each one of the third party systems 130A-N. This may be over the network 150, as previously described. In the illustrated embodiment, the computing device 160 is in communication with the third party interface 132A-N of each third party system 130A-N. Each third party interface 132A-N allows the computing device 160 to access the data feed 134A-N of the respective third party systems 130A-N.

The illustrated transaction processing system 110 comprises a system data interface 162. In particular, the computing device 160 comprises the system data interface 162. The system data interface 162 is an executable code module stored in device memory 163. The transaction processing system 110 communicates with the third party interface 132A-N via the system data interface 162. That is, the transaction processing system 110 retrieves the data of the data feeds 134A-N of each third party system 130A-N via the system data interface 162. In some embodiments, the system data interface 162 may be in the form of a normalized market data API. That is, the system data interface 162 may be able to communicate with third party systems 130A-N that provide their data in different formats. In such embodiments, the system data interface 162 may transform the data into a normalized format that is used to generate the open transaction record store 118. Although described with reference to FIG. 3, it will be appreciated that the transaction processing system 110 of FIG. 1 may also include the system data interface 162.

The illustrated transaction processing system 110 comprises an exchange value optimizer 164. In particular, the computing device 160 comprises the exchange value optimizer 164. The exchange value optimizer 164 is configured to execute a computer-implemented method 1000, as is described in more detail below. In particular, the exchange value optimizer 164 is configured to facilitate the capitalization or recapitalization of transaction processing system accounts on the third party systems 130A-N involved in the execution of a transaction request.

The illustrated computing device 160 comprises a copy of the open transaction record store 118. The open transaction record store 118 is as previously described. In some embodiments, the computing device 160 generates the open transaction record store 118 as previously described. In some embodiments, another component of the transaction processing system 110 may generate the open transaction record store 118. This other component may provide the open transaction record store 118 to the computing device 160. Alternatively, the other component may store the open transaction record store 118 in a shared memory of the transaction processing system 110, and the computing device 160 may access and/or store the open transaction record store 118 based on the open transaction record store 118 of the shared memory.

The computing device 160 is also in communication with the client device 140. The client device interface 142 may be provided by the computing device 160 or by computer-readable instructions executed by the client device 140. The user of the client device may be able to access data or available at the transaction processing system 110 (e.g. the open transaction record store 118) via the client device interface 142, as previously described.

The transaction processing system 110 comprises a plurality of transaction router systems 112A-M. Although described with reference to FIG. 3, it will be appreciated that in some embodiments, the transaction router systems 112A-M of FIG. 3 are analogous to the transaction router systems 112A-M of FIG. 1. Therefore, the transaction router systems 112A-M of FIG. 1 may each include one or more of the features disclosed with reference to the transaction router systems 112A-M of FIG. 3.

Each transaction router system 112A-M comprises a processor 165 and a memory 167. The processor 165 is configured to execute instructions stored in the memory 167 to cause the transaction router system 112A-M to function according to the described methods. In some embodiments, the instructions are in the form of instruction program code. The processor 165 may comprise one or more microprocessors, central processing units (CPUs), application specific instruction set processors (ASIPs), application specific integrated circuits (ASICs) or other processors capable of reading and executing instruction code.

The memory 167 may comprise one or more volatile or non-volatile memory types. For example, the memory 167 may comprise one or more of random access memory (RAM), read-only memory (ROM), electrically erasable programmable read-only memory (EEPROM) or flash memory. The memory 167 is configured to store program code accessible by the processor 165. The program code comprises executable program code modules. In other words, the memory 167 is configured to store executable code modules configured to be executable by the processor 165. The executable code modules, when executed by the processor 165 cause the transaction router system 112A-M to perform certain functionality, as described in more detail below.

Each transaction router system 112A-M comprises a router order execution interface 166. The router order execution interface 166 is an executable code module stored in memory 167. It will be appreciated however, that in other embodiments, the router order execution interface 166 may be a stand-alone computing device. Each transaction router system 112A-M communicates with the third party interfaces 132A-N via its router order execution interface 166. That is, the transaction router system 112A-M sends transaction requests to one or more of the third party systems 130A-N via its router order execution interface 166. In some embodiments, the router order execution interface 166 may be in the form of a normalized order execution API. One or more of the third party systems 130A-N may require inbound transaction requests to be of a particular data structure. Different third party systems 130A-N may require transactions requests with a different data structure to other third party systems 130A-N. The router order execution interface 166 may be able to communicate with each third party system 130A-N to provide one or more transaction requests in accordance with the required data structure of the respective third party system 130A-N. In such embodiments, the router order execution interface 166 may transform the transaction request from a normalized format generated by the relevant transaction router system 112A-M to the required data structure of the respective third party system 130A-N prior to sending the transaction request. Although described with reference to FIG. 3, it will be appreciated that the transaction processing system 110 of FIG. 1 may also include the router order execution interface 166.

The illustrated transaction router systems 112A-M comprise a copy of the open transaction record store 118. The open transaction record store 118 is as previously described. In some embodiments, the transaction router systems 112A-M generates the open transaction record store 118 as previously described. In such embodiments, the transaction router systems 112A-M receive the data from the data feeds 134A-N and use the data to generate the open transaction record store 118 as previously described. This may be performed independently by each transaction router system 112A-M. In some embodiments, another component of the transaction processing system 110 may generate the open transaction record store 118. This other component may provide the open transaction record store 118 to the transaction router systems 112A-M. Alternatively, the other component may store the open transaction record store 118 in a shared memory of the transaction processing system 110, and the transaction router systems 112A-M may access and/or store the open transaction record store 118 based on the open transaction record store 118 of the shared memory.

In some embodiments, one or more of the transaction router systems 112A-M may comprise the (or a copy of the) system data interface 162, transaction routing optimizer 166 and/or exchange value optimizer 164.

The illustrated transaction processing system 110 comprises a transaction processing system exchange 122, as described previously. The transaction processing system exchange 122 comprises a stablefiat cryptocurrency order store 124, also as described previously. The transaction processing system exchange 122 is in communication with each of the third party systems 130A-N, and is configured to transfer assets such as stablefiat cryptocurrencies from user accounts of the transaction processing system 110 (or transaction processing system exchange 122) to transaction processing system accounts of the third party systems 130A-N.

### Method for Optimizing Execution of a Transaction Request

The transaction processing system 110 receives information (e.g. open transactions) from each third party system 130A-N in communication with transaction processing system 110. Depending on the physical distances and the network topology between the transaction processing system 110, or components thereof that receive the information, the information may be a few hundred milliseconds old due to the RTT between the transaction processing system 110 and the respective third party systems 130A-N. Sending a transaction request to execute one of the open transactions also takes RTT/2 seconds. The open transactions may no longer be active by the time the transaction request arrives at the relevant third party system 130A-N. In this case, the transaction processing system 110 has to cancel the transaction request, and send another transaction request based on updated open order information. This inefficiency may increase slippage. This inefficiency may also increase data transmission requirements, bandwidth requirements and/or energy requirements of one or more of the components of the transaction processing system 110 (e.g. the transaction router system 112A-M and/or the computing device 160 (where relevant)). The transaction processing system 110 employs a computer-implemented method 400 of dynamically select one of the plurality of transaction router systems 112A-M to send transaction requests to the third party systems 130A-N. The appropriate transaction router system 112A-M is selected with a view of reducing the number of transaction requests sent to the third party systems 130A-N that fail to execute because a corresponding open transaction of one of the third party systems 130A-N in communication with that transaction router system 112A-M expiring within the relevant RTT. This may provide for decreased slippage. The method 400 may also provide for decreased data transmission requirements, bandwidth requirements and/or energy requirements of one or more of the components of the transaction processing system 110 (e.g. the transaction router system 112A-M and/or the computing device 160 (where relevant)).

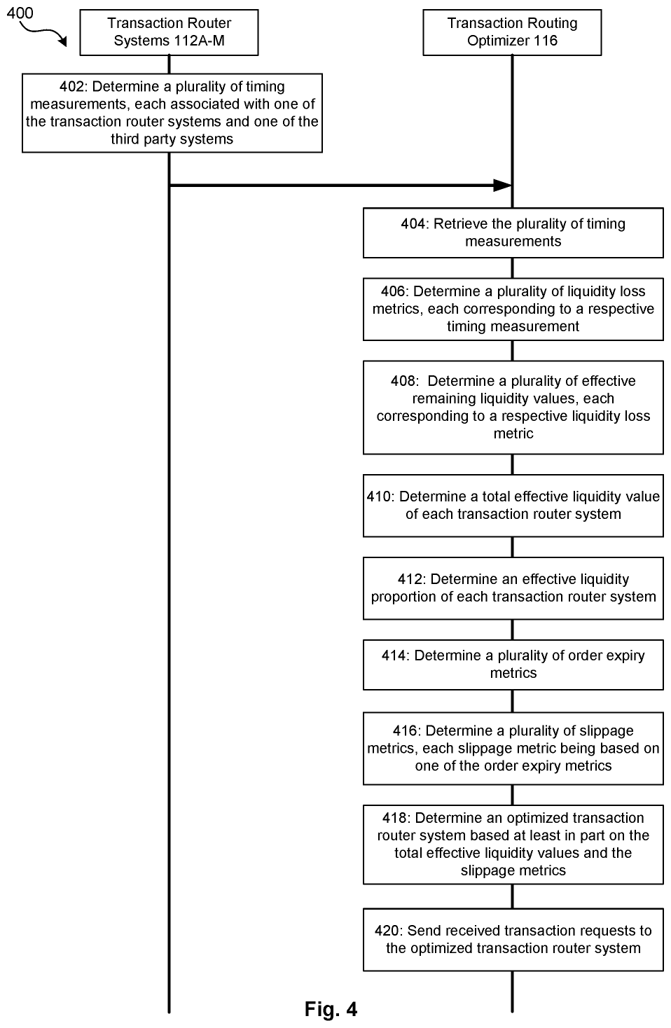

Referring now to FIG. 4, there is shown a process flow diagram of a computer implemented method 400 for optimizing execution of a transaction request according to some embodiments. The method is performed by one or more computer systems of the transaction processing system 110. In some embodiments, the transaction routing optimizer 116 performs the method 400. In some embodiments, the transaction processing system 110 described with reference to FIG. 1 performs the method 400. In some embodiments, the transaction processing system 110 described with reference to FIG. 3 performs the method 400.

At 402, the transaction processing system 110 determines a plurality of timing measurements. Each timing measurement is associated with one of the transaction router systems 112A-M and one of the third party systems 130A-N that is in communication with that transaction router system 112A-M. That is, each timing measurement is associated with a transaction router system 112A-M—third party system 130A-N pair.

Each timing measurement is indicative of a round trip time (RTT) (or alternatively another latency metric) between the transaction router system 112A-M and the third party system 130A-N that are associated with that timing measurement. In other words, each timing measurement is indicative of the RTT between the transaction router system 112A-M and third party system 130A-N of a transaction router system 112A-M—third party system 130A-N pair.

As each transaction router system 112A-M may be in communication with a plurality of third party systems 130A-N, the transaction processing system 110 determines a plurality of timing measurements. A timing measurement may be determined for each connection.

Each transaction router system 112A-M determines a timing measurement for each third party system 130A-N that is in communication with that transaction router system 112A-M. One or more of the transaction router system 112A-M may determine the respective timing measurements by pinging each of the third party systems 130A-N in communication with that transaction router system 112A-M. The timing measurements determined by each transaction router system 112A-M are associated with that transaction router system 112A-M, and the third party system 130A-N with which the timing measurement is determined with respect to. Thus, the timing measurements may be stored as a vector with one element corresponding the timing measurement, a first label corresponding to the associated transaction router system 112A-M, and a second label corresponding to the associated third party system 130A-N. The timing measurements determined by each transaction router system 112A-M may be stored locally on that transaction router system 112A-M, or may be stored in a shared memory available to other components of the transaction processing system 110. The timing measurements may be stored in the form of a timing measurement matrix that relates each timing measurement to the associated transaction router system 112A-M and third party system 130A-N. Each transaction router system 112A-M may store its timing measurement locally, for example, in memory 167. Alternatively, each transaction router system 112A-M may communicate its timing measurement to another component of the transaction processing system 110. For example, each transaction router system 112A-M may communicate its timing measurement to the computer 160, which may store the timing measurements in device memory 163.

As previously described, in some embodiments, one or more of the transaction router systems 112A-M is in communication with third party systems 130A-N that are located in a number of different geographical regions. In some embodiments, these transaction router systems 112A-M determine a regional average RTT for each of the third party systems 130A-N of a particular region that are in communication with that transaction router systems 112A-M. For example, a transaction router system 112A-M located in a first region (e.g. North America) may determine a RTT for each third party system 130A-N located in a second region (e.g. South America). The transaction router system 112A-M located in the first region may then determine an average of the RTTs determined for the third party systems 130A-N located in the second region. The transaction router system 112A-M may store this value as a regional average RTT for the second region. This may be performed for each of a plurality of regions, including the region that the transaction router system 112A-M is located.

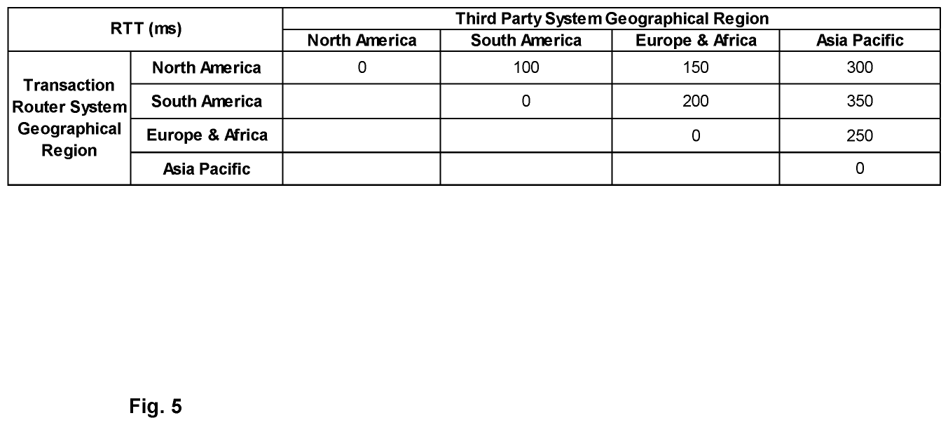

FIG. 5 illustrates a table representing example round trip times between transaction router systems 112A-M located in various geographical regions and third party systems 130A-N located in various geographical regions. For example, as illustrated in FIG. 5, the RTT between a transaction router system 112A-M and a third party system 130A-N that are both located in North America may be very small, or approximated by 0 ms. The RTT between the same transaction router system 112A-M may be appreciably larger when considering third party systems 130A-N in communication with the transaction router system 112A-M that are located in other geographical regions. In FIG. 5, this is illustrated as being approximately 100 ms, 150 ms and 300 ms for third party systems 130A-N located in South America, Europe/Africa and Asia Pacific respectively, when considering a transaction router system 112A-M located in North America.

At 404, the transaction processing system 110 retrieves the plurality of timing measurements. In particular, the transaction routing optimizer 116 retrieves the plurality of timing measurements. The transaction routing optimizer 116 may retrieve each timing measurement and store the timing measurements locally, for example, in memory 167. Alternatively, each transaction router system 112A-M may communicate its timing measurement to another component of the transaction processing system 110. For example, each transaction router system 112A-M may communicate its timing measurement to the computer 160, which may store the timing measurements in device memory 163. A processor of the transaction processing system 110 may therefore later receive the stored timing measurements for further processing. For example, the transaction routing optimizer 116 may retrieve the timing measurements from the memory 167 and the timing measurements may be received by the relevant processor of the transaction processing system 110.

At 406, the transaction processing system 110 determines a plurality of liquidity loss metrics. In particular, the transaction routing optimizer 116 determines the plurality of liquidity loss metrics. Each liquidity loss metric corresponds with one of the plurality of timing measurements. In particular, each liquidity loss metric is determined based on the corresponding timing measurement. Therefore, each liquidity loss metric is associated with the transaction router system 112A-M and the third party system 130A-N that the respective timing measurement is associated with. For example, where the timing measurement is associated with a particular transaction router system 112A-M—third party system 130A-N pair, the corresponding liquidity loss metric is also associated with that transaction router system 112A-M—third party system 130A-N pair.

As previously described, each third party system 130A-N has an open transaction liquidity. The open transaction liquidities correspond to the sum of the sum of the value amounts of one of the targets of the third party system 130A-N. Because open transactions may be cancelled, some of the open transaction liquidity of the third party systems 130A-N is unavailable to some of the transaction router systems 112A-M. This is because, in the RTT between the relevant transaction router system 112A-M and third party system 130A-N, some proportion of the open transactions will be cancelled. This proportion of the open transactions is therefore unavailable to the relevant transaction router system 112A-M, as it is unable to send a transaction request to execute these open transactions prior to their cancellation, because of the RTT between that transaction router system 112A-M and the third party system 130A-N.

Each liquidity loss metric is indicative of a proportion of the open transaction liquidity of the third party system 130A-N associated with that liquidity loss metric (and therefore, the timing measurement that is also associated with that liquidity loss metric) that is unavailable to the transaction router system 112A-M associated with that liquidity loss metric (and therefore, the timing measurement that is also associated with that liquidity loss metric).

The transaction routing optimizer 116 determines each liquidity loss metric using a liquidity loss model that relates each timing measurement to the corresponding liquidity loss metric. The liquidity loss model is a linear model. In some embodiments, according to the liquidity loss model, there is 0% liquidity lost when the RTT between a transaction router system 112A-M and a third party system 130A-N is 0 ms. This condition defines a maximum liquidity condition of the liquidity loss model. The liquidity loss model comprises a maximum RTT, which is indicative of a maximum RTT between a transaction router system 112A-M and a third party system 130A-N. This maximum RTT is practically achieved when the transaction router system 112A-M and third party system 130A-N are significantly geographically distributed. For example, in some embodiments, the maximum RTT is 400 ms. For example, the maximum possible RTT between two large financial centers in the world with a reliable internet connection is around 400 ms. The liquidity loss model comprises a maximum liquidity loss parameter. The maximum liquidity loss parameter defines a proportion of the open transaction liquidity that is lost at the maximum possible RTT. In some embodiments, the maximum liquidity loss parameter has a value of 25%. That is, according to the liquidity loss model, when the RTT between a transaction router system 112A-M and a third party system 130A-N is 400 ms, 25% of the open transaction liquidity of that third party system 130A-N is unavailable to the transaction router system 112A-M. This RTT defines a minimum liquidity condition of the liquidity loss model. The liquidity loss model defines a linear relationship between the maximum liquidity condition and the minimum liquidity condition.

In other words, the following model may relate the liquidity loss metrics to the RTTs:

LLM=K×RTT

Where RTT is the relevant round trip time, LLM is the liquidity loss metric corresponding to that RTT, and K is a model parameter. Using the maximum liquidity condition and minimum liquidity condition described previously, the model may be expressed:

LLM=0.0000625×RTT

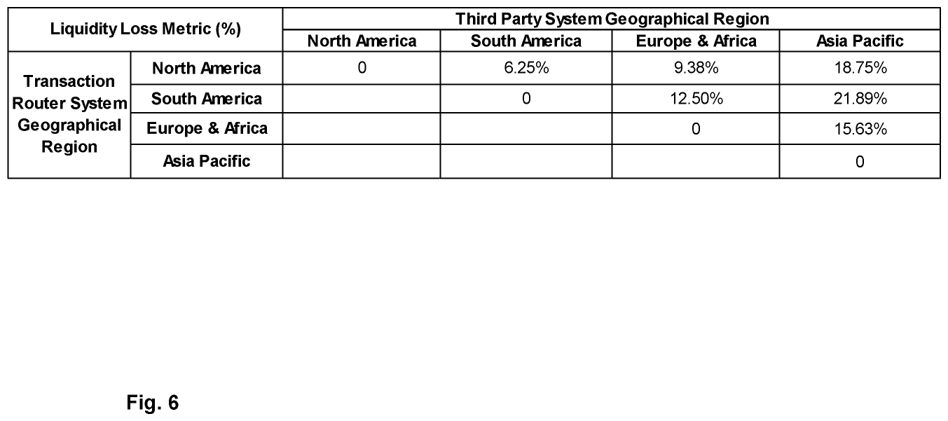

FIG. 6 illustrates a table representing example liquidity loss metrics for transaction router systems 112A-M located in various geographical regions when considered with third party systems 130A-N located in various geographical regions. These may be the transaction router systems 112A-M and third party systems 130A-N relevant to FIG. 5. The values of the table of FIG. 6 have been determined by applying the above described liquidity loss model to the RTT values of the table of FIG. 5.

Each liquidity loss metric is associated with the transaction router system 112A-M and the third party system 130A-N that are associated with the timing measurement used to determine the liquidity loss metric. Thus, the liquidity loss metrics may be appended to the relevant vector associating the timing measurement, transaction router system 112A-M, and third party system 130A-N. The liquidity loss metrics may be stored locally on the transaction processing system 110, and may be stored in a shared memory available to other components of the transaction processing system 110. For example, the liquidity loss metrics may be stored in the device memory 163 of the computing device 160. The liquidity loss metrics may be aggregated and stored in the form of a data matrix that relates each timing measurement to the associated liquidity loss metric, transaction router system 112A-M and third party system 130A-N. The data matrix may comprise each vector previously described (comprising elements corresponding to the relevant timing measurement and liquidity loss metric, and labels corresponding to the relevant transaction router system 112A-M and third party system 130A-N), as a row of the data matrix.

At 408, the transaction processing system 110 determines a plurality of effective remaining liquidity values. In particular, the transaction routing optimizer 116 determines the plurality of effective remaining liquidity values. Each effective remaining liquidity value corresponds with one of the plurality of liquidity loss metrics. In particular, each effective remaining liquidity value is determined based on one of the plurality of liquidity loss metrics.

Therefore, each effective remaining liquidity value can be said to correspond with one of the plurality of timing measurements. In particular, each effective remaining liquidity value can be said to correspond with the timing measurement that corresponds to the liquidity loss metrics to which the effective remaining liquidity value corresponds. Each effective remaining liquidity value is therefore associated with the transaction router system 112A-M and the third party system 130A-N that are associated with the corresponding liquidity loss metric and timing measurement.

For example, where the liquidity loss metric that is used to determine one of the effective remaining liquidity values is associated with a particular transaction router system 112A-M—third party system 130A-N pair, the effective remaining liquidity value is also associated with that transaction router system 112A-M—third party system 130A-N pair. The effective remaining liquidity value is indicative of a proportion of the open transaction liquidity of the third party system 130A-N of the pair that is available to the transaction router system 112A-M of the pair.

Thus, each effective remaining liquidity value is indicative of a proportion of the open transaction liquidity of the third party system 130A-N associated with the effective remaining liquidity value that is available to the transaction router system 112A-M associated with effective remaining liquidity value.

In other words, a RTT is determined at 402 for a transaction router system 112A-M -third party system 130A-N pair. At 406, the transaction routing optimizer 116 determines a liquidity loss metric for that pair, based on the determined RTT. Therefore, the liquidity loss metric is associated with that pair. At 408, the transaction routing optimizer 116 determines an effective remaining liquidity value for that pair, based on the determined liquidity loss metric. Therefore, the effective remaining liquidity value is associated with that pair. The transaction routing optimizer 116 performs this process for each transaction router system 112A-M—third party system 130A-N pair in parallel.

The transaction routing optimizer 116 determines each effective remaining liquidity value by determining the compliment of the corresponding liquidity loss metric. That is:

ERLV=(1−LLM)

Where ERLV is the relevant effective remaining liquidity value, and LLM is the liquidity loss metric expressed as a decimal.

Each effective remaining liquidity value is associated with the transaction router system 112A-M and the third party system 130A-N that are associated with the liquidity loss metric used to determine the effective remaining liquidity value. Thus, the effective remaining liquidity values may be appended to the relevant vector associating the timing measurement, liquidity loss metric, transaction router system 112A-M, and third party system 130A-N. The effective remaining liquidity values may be stored locally on the transaction processing system 110, and/or may be stored in a shared memory available to other components of the transaction processing system 110. For example, the effective remaining liquidity values may be stored in the device memory 163 of the computing device 160. The effective remaining liquidity values may be aggregated and stored in the form of a data matrix that relates each effective remaining liquidity value to the associated timing measurement, liquidity loss metric, transaction router system 112A-M and third party system 130A-N. The data matrix may comprise each vector previously described (comprising elements corresponding to the relevant timing measurement, liquidity loss metric and effective remaining liquidity value, and labels corresponding to the relevant transaction router system 112A-M and third party system 130A-N), as a row of the data matrix.

At 410, the transaction processing system 110 determines a total effective liquidity value of each transaction router system 112A-M. In particular, the transaction routing optimizer 116 determines the total effective liquidity value of each transaction router system 112A-M. As previously described, each effective remaining liquidity value is associated with transaction router system 112A-M—third party system 130A-N pair. Therefore, each effective remaining liquidity value is associated with the transaction router system 112A-M of that pair. The transaction routing optimizer 116 determines the total effective liquidity value of each transaction router system 112A-M by summing the effective remaining liquidity values that are associated with the relevant transaction router system 112A-M. The transaction routing optimizer 116 performs this for each transaction router system 112A-M of the transaction processing system 110.

Each total effective liquidity value is associated with one of the transaction router systems 112A-M. The total effective liquidity values may be stored locally on the transaction processing system 110, and may be stored in a shared memory available to other components of the transaction processing system 110. For example, the total effective liquidity values may be stored in the device memory 163 of the computing device 160. The total effective liquidity values may be aggregated and stored in the form of a data matrix that relates each total effective liquidity values to the associated transaction router system 112A-M.

At 412, the transaction processing system 110 determines an effective liquidity proportion of each transaction router system 112A-M. In particular, the transaction routing optimizer 116 determines the effective liquidity proportion of each transaction router system 112A-M. Each effective liquidity proportion is indicative of a ratio between the total effective liquidity value of the respective transaction router system 112A-M and a total liquidity. The total liquidity is a sum of the open transaction liquidities of each third party system 130A-N that is in communication with the respective transaction router system 112A-M.

That is, each effective liquidity proportion is determined by:

$$ELP = \frac{TELV}{TL}$$

Where ELP is the effective liquidity proportion of one of the transaction router systems 112A-M, TELV is the total effective liquidity value associated with that transaction router systems 112A-M, and TL is the total liquidity of that transaction router system 112A-M (i.e. the sum of the open transaction liquidities of each third party system 130A-N that is in communication with the transaction router system 112A-M.

Each effective liquidity proportion is associated with one of the transaction router systems 112A-M. The effective liquidity proportions may be stored locally on the transaction processing system 110, and/or may be stored in a shared memory available to other components of the transaction processing system 110. For example, the effective liquidity proportions may be stored in the device memory 163 of the computing device 160. The effective liquidity proportions may be aggregated and stored in the form of a data matrix that relates each effective liquidity proportion to the associated transaction router system 112A-M.

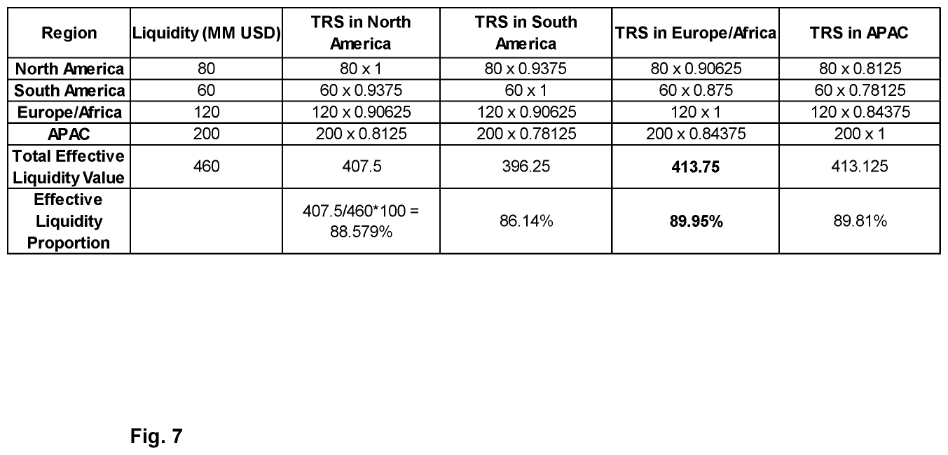

FIG. 7 illustrates a table representing example total liquidity values (“Liquidity (MM USD)”), total effective liquidity values and effective liquidity proportions for transaction router systems 112A-M (TRS) located in various geographical regions (North America, South America, Europe/Africa and APAC). Each of the total effective liquidity values is determined as previously described. Each of the effective liquidity proportions is determined as previously described.

At 414, the transaction processing system 110 determines a plurality of order expiry metrics. In particular, the transaction routing optimizer 116 determines the plurality of order expiry metrics. Each order expiry metric is associated with one of the plurality of transaction router systems 112A-M. Each order expiry metric is indicative of an average number of transaction requests sent from the associated transaction router system 112A-M that fail to execute because of a corresponding open transaction of one of the third party systems 130A-N in communication with that transaction router system 112A-M expiring within the relevant RTT.

In some embodiments, the transaction routing optimizer 116 determines the number of transaction requests sent from the associated transaction router system 112A-M that fail to execute because of a corresponding open transaction of one of the third party systems 130A-N in communication with that transaction router system 112A-M expiring within the relevant RTT. This may be done using the executed transaction record history store. That is, the transaction routing optimizer 116 can compare the transactions requests sent to each third party system 130A-N with the transaction requests that actually execute to determine those that fail to execute because of a corresponding open transaction closing in the relevant RTT. In some embodiments, the transaction routing optimizer 116 also uses the open transaction record history store to determine the number.

The transaction routing optimizer 116 determines the average number of transaction requests sent from a respective transaction router system 112A-M that fail to execute because of a corresponding open transaction expiring within the relevant RTT based on the determined number of transaction requests sent from the respective transaction router system 112A-M that fail to execute. In some embodiments, the transaction routing optimizer 116 determines the average by summing the number of transaction requests that fail because of the RTT for each third party system 130A-N in communication with the relevant transaction router system 112A-M, and dividing the sum by the number of third party systems 130A-N. This average number is the order expiry metric of the relevant transaction router system 112A-M.

Open transactions on a particular third party system 130A-N may be ordered, and executed based on a parameter of the open transactions. For example, open transactions may be ordered based on the value amount of each of the open transactions. The open transactions are executed sequentially. For example, where the open transactions represent offers to sell an asset (and therefore, opportunities for another entity to buy the asset from the entities selling the asset), open transactions with lower value amounts will be executed before higher value amount open transactions. The open transactions of each third party system 130A-N therefore define an order book of that third party system 130A-N. Each open transaction of the order book has an associated order depth. The order depth of the open transaction is the position of the open transaction in the order book. The first open transaction of the order book has an order depth of 1, and the nth order of the order book has an order depth of n. Open transactions at a top of the order book (i.e. closer to the first open transaction of the order book) are crossed (executed) more often than open transactions deeper into the order book. This is because execution of the open transactions is prioritized based on the depth of the open transactions in the order book. That is, to execute an open transaction of order depth n, each open transaction between the order depths of 1 and n-1 must be executed first.

Therefore, in some embodiments, determination of the order expiry metrics may take into account the fact that open transactions at the top of the order book are more likely to be executed than those deeper in the order book.

In some embodiments, at 414, the transaction processing system 110 determines a plurality of order expiry metrics, each order expiry metric being indicative of an average number of transaction requests sent from the associated transaction router system 112A-M that fail to execute because of a corresponding open transaction of a particular order depth of one of the third party systems 130A-N in communication with that transaction router system 112A-M expiring within the relevant RTT. That is, one transaction router system 112A-M has a plurality of associated order expiry metrics, with each order expiry metric being indicative of the probability a transaction request failing to execute an open order of one of a plurality of order depths.

For example, transaction routing optimizer 116 may determine, based on the executed transaction record history store, that some number of transaction requests sent from one of the transaction router systems 112A-M to one of the third party systems 130A-N fail to execute because the corresponding open transaction expired within the relevant RTT, and the open transaction was of order depth 1. The transaction routing optimizer 116 may also determine that some number of transaction requests sent from one of the transaction router systems 112A-M to one of the third party systems 130A-N fail to execute because the corresponding open transaction expired within the relevant RTT, and the open transaction was of order depth 2. The transaction routing optimizer 116 may determine an equivalent number for open transactions to order depth n. The transaction routing optimizer 116 may determine equivalent numbers for each third party system 130A-N in communication with that transaction router system 112A-M. The transaction routing optimizer 116 may then determine a mean number for each order depth. For example, the transaction routing optimizer 116 may determine a mean number of transaction requests sent from one of the transaction router systems 112A-M to one of the third party systems 130A-N that fail to execute because the corresponding open transaction expired within the relevant RTT, and the open transaction was of order depth 1. This mean may be an order expiry metric associated with that transaction router system 112A-M for orders of a first depth. The transaction routing optimizer 116 may similarly determine order expiry metrics associated with that transaction router system 112A-M for orders of n depth. The transaction routing optimizer 116 may similarly determine order expiry metrics associated with every other transaction router system 112A-M for each of the n depths of the respective order books.

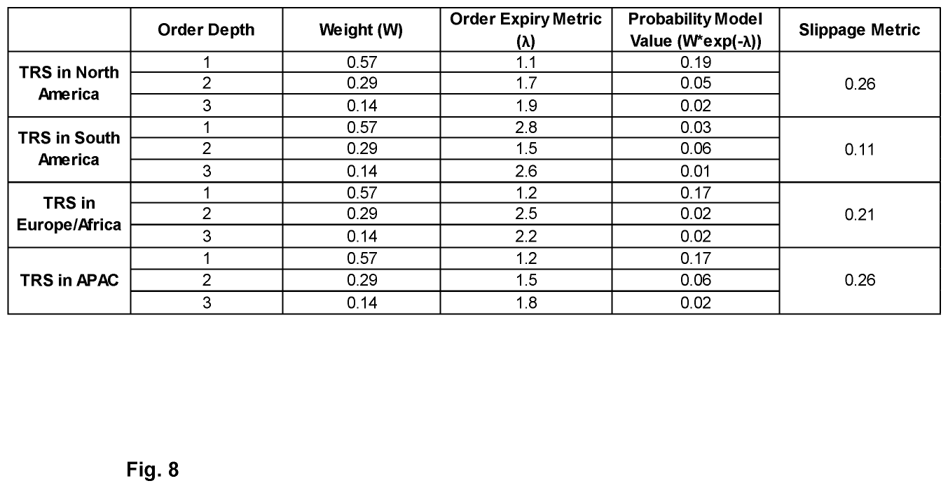

FIG. 8 illustrates example order expiry metrics for 3 order depths of a number of transaction router systems 112A-M located in different geographical regions. For example, the average number of transaction requests sent from one of the transaction router systems 112A-M to one of the third party systems 130A-N that fail to execute because the corresponding open transaction expired within the relevant RTT, the open transaction being of order depth 1, for the transaction router system 112A-M located in North America is 1.1. That is, an average of 1.1 transactions requests fail under this condition for order depth 1 of the North American transaction router system 112A-M. The average number of transaction requests sent from one of the transaction router systems 112A-M to one of the third party systems 130A-N that fail to execute because the corresponding open transaction expired within the relevant RTT, the open transaction being of order depth 2, for the transaction router system 112A-M located in North America is 1.7.

Each order expiry metric is associated with the relevant transaction router system 112A-M. The order expiry metrics may be stored locally on the transaction processing system 110, and/or may be stored in a shared memory available to other components of the transaction processing system 110. For example, the order expiry metrics may be stored in the device memory 163 of the computing device 160. The order expiry metrics may be aggregated and stored in the form of a data matrix that relates each order expiry metric to the associated transaction router system 112A-M.

At 416, the transaction processing system 110 determines a plurality of slippage metrics. In particular, the transaction routing optimizer 116 determines the plurality of slippage metrics. Each slippage metric is determined based on one of the order expiry metrics. Each slippage metric is associated with one of the plurality of transaction router systems 112A-M. In particular, each slippage metric is associated with the transaction router system 112A-M that the corresponding order expiry metric(s) is associated with.

Each slippage metric is indicative of a probability that a transaction request sent from the relevant transaction router system 112A-M will fail to execute because of a corresponding open transaction of one of the third party systems 130A-N in communication with that transaction router system 112A-M expiring within the relevant RTT (i.e. the RTT between the transaction router system 112A-M and that third party system 130A-N). In particular, each slippage metric is indicative of a probability that no transaction request sent from the relevant transaction router system 112A-M will fail to execute because of a corresponding open transaction of one of the third party systems 130A-N in communication with that transaction router system 112A-M expiring within the relevant RTT. This may be equivalent to an estimate of the probability that there will be no slippage.

The transaction routing optimizer 116 determines each slippage metric using a slippage model that relates each order expiry metric to the corresponding slippage metric.

As previously described, in some embodiments, transaction routing optimizer 116 determines a single order expiry metric for each transaction router system 112A-M. In these cases, the order expiry metric is indicative of the average number of transaction requests sent from the associated transaction router system 112A-M that fail to execute because of the corresponding open transaction of one of the third party systems 130A-N in communication with that transaction router system 112A-M expiring within the relevant RTT. In these cases, the slippage model models each slippage metric according to a Poisson distribution

$$P ( x ) = \frac{{λ}^{x} \times {e}^{- λ}}{x !}$$

Where P(x) is the probability of x transaction requests sent from the relevant transaction router system 112A-M to the relevant third party system 130A-N failing to execute because of a corresponding open transaction expiring within the relevant RTT. λ (the scale factor) is the relevant order expiry metric. The slippage metric of the relevant transaction router system 112A-M corresponds to P(0). That is, the slippage metric is indicative of the probability of no slippage (i.e. the probability that no transaction requests will fail to execute).

In other words, the slippage model may be represented as:

SM=e^{-λ}

Where SM is the slippage metric and λ is the corresponding order expiry metric.

As previously described, in some embodiments, the transaction routing optimizer 116 determines a plurality of order expiry metrics associated with each transaction router system 112A-M, with each order expiry metric indicating the number of transaction requests sent from that transaction router system 112A-M to one of the third party systems 130A-N fail to execute because the corresponding open transaction expired within the relevant RTT, and the open transaction was of one of order depths 1-n. n may, for example, be 3. In these embodiments, to determine the slipping metric of one of the transaction router systems 112A-M, the transaction routing optimizer 116 may determine a plurality of probability model values, with each probability model value being determined based on one of the order expiry metrics.

The probability model values may be determined based on the order expiry metrics, according to:

PMVᵢ=Wᵢ×e^{-λ}^{ᵢ}

Where PMVᵢ is the probability model value of the order expiry metric corresponding to the ith order depth of the relevant transaction router system 112A-M, Wᵢ is a weight factor for the order expiry metric corresponding to the ith order depth of the relevant transaction router system 112A-M, and λᵢ is the order expiry metric of the ith order depth of the relevant transaction router system 112A-M. The weight factors are applied because open transactions of order depth 1 are more likely to be executed by a transaction request than open transactions of order depth 2-n. The weight factors may therefore be defined such that:

W₁>W₂ . . . >Wₙ

The weight factor of a second order depth may be half the weight factor of a first order depth, where the first order depth is 1 order depth higher than the second order depth. For example, as shown in FIG. 8, the weight factor of order depth 1 is 0.57, whereas the weight factor of order depth 2 is 0.29, which is approximately half of the weight factor of order depth 1. In other words:

$${W}_{i + 1} = \frac{{W}_{i}}{2}$$

The sum of the weight factors may add to 1. For example:

$${\sum }_{i = 1}^{n} {W}_{i} = 1$$

The transaction routing optimizer 116 determines a probability model value for each order expiry metric associated with each transaction router system 112A-M.

FIG. 8 illustrates a number of example probability model values determined for a number of transaction router systems 112A-M. As is seen in FIG. 8, each order depth has an associated order expiry metric, and therefore an associated probability model value.

In some embodiments, order expiry metrics and probability model values are only determined for the first 3 order depths (i.e. order depths 1-3). This can increase the efficiency of determining the slippage metrics, because orders beyond those order depths are not usually executed.

The transaction routing optimizer 116 determines the slippage metric of each transaction router system 112A-M by summing the probability model values associated with the respective transaction router system 112A-M.

FIG. 8 illustrates a number of example slippage metrics determined for a number of transaction router systems 112A-M. As is seen in FIG. 8, each transaction router system 112A-M is associated with a corresponding slippage metric. The slippage metrics of FIG. 8 are the sum of the probability model values of the relevant transaction router system 112A-M.

Each slippage metric is associated with one of the transaction router systems 112A-M. The slippage metrics may be stored locally on the transaction processing system 110, and/or may be stored in a shared memory available to other components of the transaction processing system 110. For example, the slippage metrics may be stored in the device memory 163 of the computing device 160. The slippage metrics may be aggregated and stored in the form of a data matrix that relates each slippage metrics to the associated transaction router system 112A-M.

At 418, the transaction processing system 110 determines an optimized transaction router system. In particular, the transaction routing optimizer 116 determines the optimized transaction router system. The optimized transaction router system is one of the plurality of transaction router systems 112A-M.

In some embodiments, the transaction routing optimizer 116 determines the optimized transaction router system based at least in part on the total effective liquidity values. Determining the optimized transaction router system may comprise determining the transaction router system 112A-M with the largest associated total effective liquidity value. The transaction routing optimizer 116 may select the transaction router system 112A-M with the largest associated total effective liquidity value as the optimized transaction router system. With reference to FIG. 7, for example, the transaction router system 112A-M located in Europe/Africa has the largest associated effective liquidity value, and would therefore be determined to be the optimized transaction router system.

In some embodiments, the transaction routing optimizer 116 determines the optimized transaction router system based at least in part on the determined effective liquidity proportions. Determining the optimized transaction router system may comprise determining the transaction router system 112A-M with the largest associated effective liquidity proportion. The transaction routing optimizer 116 may select the transaction router system 112A-M with the largest associated effective liquidity proportion as the optimized transaction router system. With reference to FIG. 7, for example, the transaction router system 112A-M located in Europe/Africa has the largest associated effective liquidity proportion, and would therefore be determined to be the optimized transaction router system.

Although the total effective liquidity values and effective liquidity proportions can be used to determine the optimized transaction router system as previously described, it can be advantageous to take other factors into consideration. For example, in many situations, open transactions that are those most likely to expire within a RTT between one of the transaction router systems 112A-M and one of the third party systems 130A-N are generally those which have a short lifespan to begin with. Such open transactions tend to be provided by quantitative traders through programmable interfaces (APIs, FIX etc.). Open transactions provided by traders through a manual order entry interface (e.g. a website) tend to have a longer lifespan, and tent to be less impacted by longer RTTs. That is, these manually entered orders are less likely to expire in a respective RTT.

In some embodiments, the transaction processing system 110 therefore takes into consideration the varying probability of missing an open transaction because of its variable lifespan. This is because it is possible that a third party system 130A-N may have a relatively long RTT, however, if the entities providing the open orders on the third party system 130A-N tend to be manually entering the orders, the large RTT may not have a significant impact on the transaction request slippage experienced with that third party system 130A-N.

In some embodiments, the transaction routing optimizer 116 determines the optimized transaction router system based at least in part on the slippage metrics. Determining the optimized transaction router system may comprise determining the transaction router system 112A-M with the largest associated slippage metric. The transaction routing optimizer 116 may select the transaction router system 112A-M with the largest associated slippage metrics as the optimized transaction router system.

As previously described, the order expiry metric and slippage metric take into consideration the average number of open transactions expiring within a RTT of a respective third party system 130A-N. The transaction processing system 110 can therefore use the order expiry metrics and slippage metrics in its determination of the optimized transaction router system, and may improve the execution of transaction requests by doing so.

In some embodiments, the transaction routing optimizer 116 determines the optimized transaction router system based at least in part on the total effective liquidity values and the slippage metrics. As previously described, each transaction router system 112A-M is associated with a respective total effective liquidity value and slippage metric. The transaction routing optimizer 116 determines the optimized transaction router system by determining an optimization metric of each transaction router system 112A-M. The optimization metric of one of the transaction router systems 112A-M is the product of the total effective liquidity value and the slippage metric that are associated with that transaction router system 112A-M. In other words:

ρᵢ=TELVᵢ×SMᵢ

Where ρᵢ is the optimization metric of the ith transaction router system 112A-M, TEVᵢ is the total effective liquidity value of the ith transaction router system 112A-M and SMᵢ is the slippage metric of the ith transaction router system 112A-M. The transaction routing optimizer 116 selects the transaction router system 112A-M with the largest associated optimization metric as the optimized transaction router system (i.e. max(ρᵢ) for i∈[A, M]).

In some embodiments, the transaction routing optimizer 116 determines the optimized transaction router system based at least in part on the effective liquidity proportions and the slippage metrics. As previously described, each transaction router system 112A-M is associated with a respective effective liquidity proportion and slippage metric. The transaction routing optimizer 116 determines the optimized transaction router system by determining an optimization metric of each transaction router system 112A-M. The optimization metric of one of the transaction router systems 112A-M is the average of the effective liquidity proportion and the slippage metric that are associated with that transaction router system 112A-M. In other words:

$${ρ}_{i} = avg ( {ELP}_{i} , {SM}_{i} ) = \frac{{ELP}_{i} + {SM}_{i}}{2}$$

Where ρᵢ is the optimization metric of the ith transaction router system 112A-M, ELPᵢ is the effective liquidity proportion of the ith transaction router system 112A-M and SMᵢ is the slippage metric of the ith transaction router system 112A-M. The transaction routing optimizer 116 selects the transaction router system 112A-M with the largest associated optimization metric as the optimized transaction router system (i.e. max(ρᵢ) for i∈[A, M]).

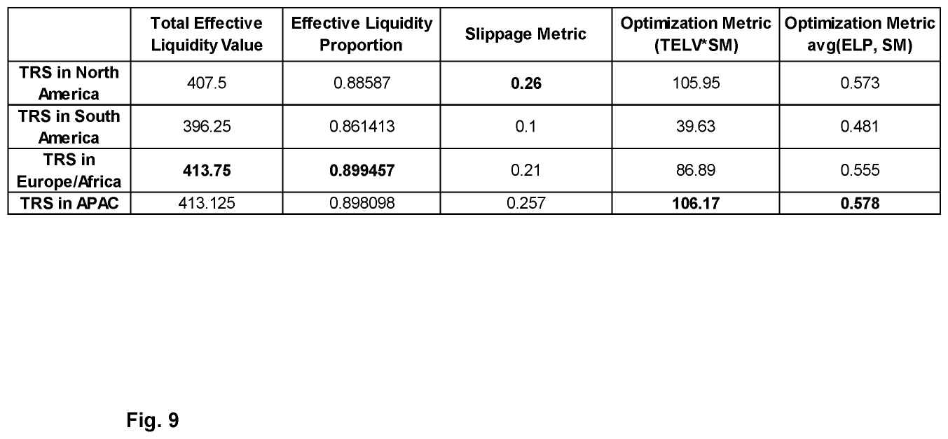

FIG. 9 illustrates optimization metrics determined for each of the transaction router systems 112A-M detailed in FIGS. 5 to 8. If the optimized transaction router system is selected from the example transaction router systems 112A-M of FIG. 9 based on either of the total effective liquidity values or the effective liquidity proportions as previously described, a transaction router system 112A-M located in Europe or Africa would be determined to be the optimized transaction router system. If the optimized transaction router system is determined based on the slippage metrics, a transaction router system 112A-M located in North America would be determined to be the optimized transaction router system. If the optimized transaction router system is determined based on the total effective liquidity and the slippage metric, or the effective liquidity proportion and the slippage metric, a transaction router system 112A-M located in the Asia Pacific Region is determined to be the optimized transaction router system.

At 420, the transaction processing system 110 sends a received transaction request to the optimized transaction router system. In particular, the transaction routing optimizer 116 sends the received transaction request to the optimized transaction router system. The optimized transaction router system is configured to send the transaction request, or a part thereof to one or more of the third party systems 130A-N to execute one or more of the open transactions. In some embodiments, the optimized transaction router system is configured to execute the transaction request in accordance with the method 200 described previously. In some embodiments, the optimized transaction router system is configured to send the transaction request(s) via one or more intermediate computing devices. The transaction request may be received by the transaction processing system 110, or a component thereof, for example the optimized transaction router system, or one of the other transaction router systems.

The transaction processing system 110 is configured to send received transaction requests via the optimized transaction router system for a time period. For example, the time period may be 10 minutes, 1 hour or 1 day. After the expiry of the time period, the transaction processing system 110 is configured to re-execute the method 400 to determine an updated optimized transaction router system. The transaction processing system 110 is configured to send received transaction requests to the updated optimized transaction router system for the time period. This process is repeated for the lifetime of the transaction processing system 110.

### Further Example of a Transaction Processing System

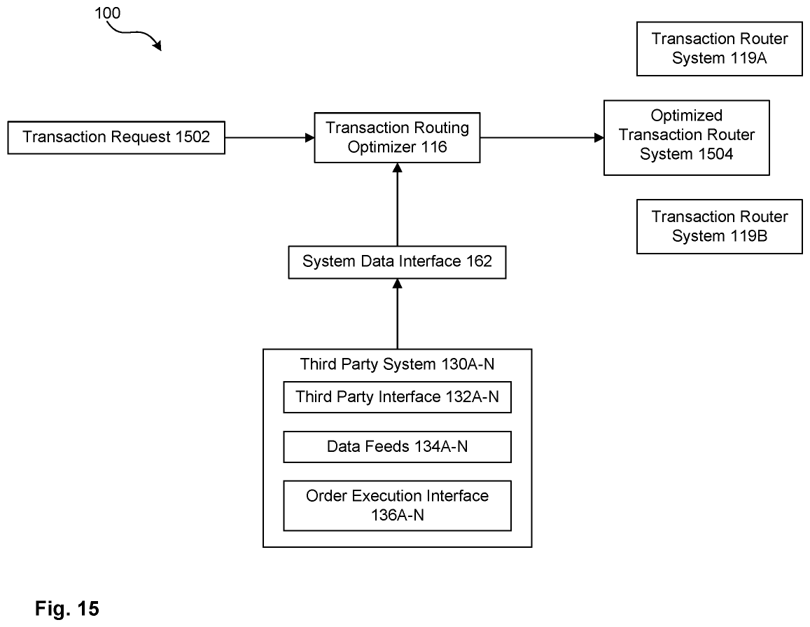

FIG. 15 illustrates a block diagram showing communication of a number of components of an example system 100 in accordance with some embodiments. The system 100 illustrated in FIG. 15 may be that disclosed with reference to FIG. 1 or FIG. 3. The system 100 illustrated in FIG. 15 may be an alternative embodiment of the system 100. As illustrated, the information of the data feeds 134A-N is provided to the transaction routing optimizer 116 via the system data interface 162. That is, the system data interface 162 retrieves the information of the data feeds 134A-N of the third party systems 130A-N and transform the data into a normalized format useful to the transaction optimization router 116. The transaction optimization router 116 determines an optimized transaction router system 1504, as previously disclosed. A transaction request is provided to the transaction optimization router 116, which directs the transaction request 1502 to the optimized transaction router system 1504. Also shown are transaction router systems 119A and 119B. These are respective transaction router systems that may communicate with the third party systems 130A-N, however, based on current RTT and liquidity conditions, were determined not the optimized transaction router system 1504. These transaction router systems 119A, 119B may therefore be considered inactive transaction router systems. It will be appreciated that, although only transaction router systems 119A, 119B are shown as inactive transaction router systems, each of transaction router systems 119A-N will be an inactive transaction router system, except for that which was determined to be the optimized transaction router system.

In some embodiments, the transaction routing optimizer 116 is configured to analyze the executed transaction record history store to determine the best method of determining the optimized transaction router system. That is, the transaction routing optimizer 116 may determine which metric provides the best predictive indicator of minimizing the extent of slippage. In other words, the transaction routing optimizer 116 may analyze the executed transaction record history store to determine which of the total effective liquidity values, the effective liquidity proportions, the slippage metrics, the optimization metrics based on the total effective liquidity values and the slippage metrics or the optimization metrics based on the effective liquidity proportions and the slippage metrics provide the best predictive indicator of minimizing the extent of slippage.

The best predictive indicator may be determined for a particular time period, and the optimized transaction router system may be determined based on this predictive indicator. After a period of time, the transaction routing optimizer 116 may re-analyze the executed transaction record history store to re-determine the best predictive indicator in light of new executed transaction record history store data.

### Capitalization of Account Balances of the Transaction Processing System

As previously described, transaction requests provided to the transaction processing system 110 by users, for example, via the client device 140 are sent, via an optimized transaction router system 112A-M to one or more of the third party systems 130A-N for execution. The execution of a transaction request typically involves the transfer of control of one asset from a first entity (i.e. the operator of the transaction processing system 110) to a second entity, in exchange for the transfer of control of another asset from the second entity to the first entity.

Also as previously described, the operator of the transaction processing system 110 may maintain a balance of one or more assets on each third party system 130A-N. These balances may be maintained in an account the operator of the third party transaction system 110 holds on each third party systems 130A-N. The balances of these accounts may be drawn on when executing a transaction request, or part thereof on the third party exchange 130A-N on behalf of the user who submitted the transaction request. Therefore, upon executing a transaction request, or part thereof on one of the third party systems 130A-N, a balance of a first asset may be drawn from the account of the transaction processing system 110 on that third party system 130A-N, and a balance of a second asset may be deposited into the account of the transaction processing system 110. A need therefore exists to provide a low-friction way of withdrawing the second asset, and providing the second asset to the user of the transaction processing system 110. A need also exists to either capitalize the balance of the first asset on the third party system 130A-N that was used to execute the transaction request prior to execution of the transaction request, or recapitalize the balance of the first asset after execution of the transaction request.

These needs are compounded on by the fact that a single transaction request may be executed on a plurality of third party systems 130A-N, as described herein, to optimize the value received in the transaction request. As one or more of the third party systems 130A-N used to execute the transaction request may be in different jurisdictions, the portion of the transaction requests may be executed in exchange for different assets. For example, where a transaction request is associated with purchasing a cryptocurrency, the cryptocurrency purchase may be split across third party systems 130A-N that offer cryptocurrency exchange markets in each of their local fiat currencies. The transaction request may therefore be executed, in part, on a North American third party system 130A-N in exchange for United States Dollars, and an Australian third party system, in exchange for Australian dollars. There is therefore a need to recapitalize the balances of a number of different assets on a number of different third party systems 130A-N that may be unrelated (i.e. operated by different entities), and may be geographically distributed.

As previously described, the transaction processing system 110 can comprise a transaction processing system exchange 122, that can facilitate the exchange of one or more fiat currencies for one or more corresponding stablefiat cryptocurrencies. Furthermore, the transaction processing system exchange 122 is in communication with each third party system 130A-N, and is able to facilitate the transfer of one or more assets (e.g. stablefiat cryptocurrencies) from the transaction processing system exchange 122 to the transaction processing system account of the relevant third party system 130A-N. Transferring ordinary fiat currency using the traditional banking system can take a number of days, and be associated with a very high transfer cost.

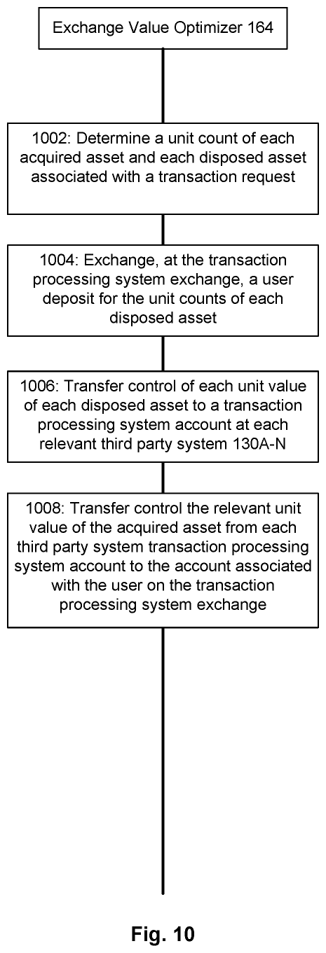

Referring now to FIG. 10, there is shown a process flow diagram of a computer implemented method 1000 of recapitalizing account balances of the transaction processing system 110 at each third party system 110. The method is performed by one or more computer systems of the transaction processing system 110. In some embodiments, the exchange value optimizer 164 performs the method 1000. Execution of a transaction request transfers control of a disposed asset from the transaction processing system 110 to the entity that placed the relevant open transaction, and transfers control of an acquired asset from the entity to the transaction processing system 110. The method 1000 provides for the capitalization or recapitalization of account balances of the transaction processing system 110 at each third party system 110 utilized in the execution of a transaction request. The method also provides for the timely delivery of the acquired asset to the user of the transaction processing system 110.

At 1002, the transaction processing system 110 determines a unit count of each acquired asset and each disposed asset associated with a transaction request. In particular, the exchange value optimizer 164 determines the unit counts. As the transaction request may be executed across a number of third party systems 130A-N, a number of different disposed assets (e.g. a USD stablefiat cryptocurrency, a GBP stablefiat cryptocurrency) may be associated with one transaction request provided by a user of the transaction processing system 110. Furthermore, the unit count of the acquired asset is likely to be different on each third party system 130A-N involved in the transaction request.

At 1004, the transaction processing system 110 exchanges a user transaction processing system exchange deposit for the unit counts of each disposed asset at the transaction processing system exchange 122. In particular, the exchange value optimizer 164 exchanges the user transaction processing system exchange deposit for the unit counts of each disposed asset at the transaction processing system exchange 122. One or more of the disposed assets may be a stablefiat currency. Control of one or more of the stablefiat currencies may be transferred via a public blockchain, or a private blockchain. The user transaction processing system exchange deposit is a deposit provided by the user that provided the transaction request. The user transaction processing system exchange deposit is a deposit made in a base asset. The base asset may, for example, be the local fiat currency used by the user. The user deposits the user transaction processing system exchange deposit into an account associated with the user on the transaction processing system exchange 122. In performing the exchange, the exchange value optimizer 164 calculates the expected cost of converting between different stablefiat cryptocurrencies based on the stablefiat cryptocurrency order store 124. The exchange value optimizer 164 then executes the exchange. Step 1004 may be performed prior to execution of the transaction request, if the operator prefers to capitalize their accounts on the relevant third party systems 130A-N prior to execution of the transaction request. Alternatively, step 1004 may be performed after execution of the transaction request, to recapitalize the accounts if the operator prefers.

At 1006, the transaction processing system 110 transfers control of each unit value of each disposed asset to a transaction processing system account at each relevant third party system 130A-N. In particular, the exchange value optimizer 164 transfers control of each disposed asset to the transaction processing system account at each relevant third party system 130A-N. The execution of these transfers capitalizes or recapitalizes the transaction processing system accounts that were involved in execution of the transaction request. For the purposes of this disclosure, the term “capitalizes” may be considered to encompass both providing the asset prior to execution of the transaction request, and providing the asset after execution of the transaction request (i.e. recapitalizing the account).

At 1008, the transaction processing system 110 transfers control of the relevant unit count of the acquired asset from each third party system transaction processing system account at each relevant third party system 130A-N to the account associated with the user on the transaction processing system exchange 122. In particular, the exchange value optimizer 164 may execute this transfer of control. Therefore, a total unit count of the acquired asset is available to the user. The user may withdraw the acquired asset, or use it in subsequent exchanges as they see fit.

Stablefiat cryptocurrencies advantageously allow for near instantaneous transfer of value from the transaction processing system exchange 122 to each third party system 130A-N. The user transaction processing system exchange deposit can therefore be extremely quickly exchanged for the relevant stablefiat cryptocurrencies, which can be nearly instantaneously transferred to the relevant transaction processing system accounts at each relevant third party system 130A-N to recapitalize these accounts to facilitate the execution of further transaction requests. This may be achieved, for example, nearly simultaneously with the execution of the transaction request. This can reduce the time the operator of the transaction processing system 110 has undercapitalized accounts on the third party systems 130A-N.

The present disclosure therefore provides for a system 100 and a transaction processing system 110 that facilitates the use of a global liquidity pool. The transaction processing system 110 is able to intelligently route transaction requests between third party systems 130A-N. Furthermore, the transaction processing system 110 is able to, virtually instantly, transfer control of assets between regional liquidity pools, via the transaction processing system exchange 122. By making this global liquidity pool available to users of the transaction processing system 110, regardless of the currency which with they use to provide a deposit, the users can take advantage of the best prices of the relevant asset globally. Execution of the user's transaction requests is optimized based on global liquidity and latency conditions at a given point in time, or over a given time period.

In some embodiments, proxy coins may be used to transfer value, the disposed asset and/or the acquired asset (e.g. from the transaction processing system 110 to one or more of the third party systems 130A-N). In some embodiments, shadow coins may be used to transfer value (e.g. from the transaction processing system 110 to one or more of the third party systems 130A-N). In some embodiments, bridge networks may be used to transfer value (e.g. from the transaction processing system 110 to one or more of the third party systems 130A-N). This may involve one or more participants pledging fiat or a cryptocurrency in a common secure custodied account. An alternative coin may be issued to represent the custodied assets. The alternative coin may circulate on a private blockchain. Settlements of the transfer of control of the alternative coin may therefore be virtually instantaneous. In some embodiments, assets (e.g. the disposed asset) could be stored in a multi-signature wallet. A centralized trusted party may be designated to conduct transfers between participants (e.g. the transaction processing system 110 and one or more of the third party systems 130A-N).

### Example of Blockchain Architecture

FIG. 12 is a block diagram illustrating a chain of transactions broadcasted and recorded on a blockchain, in accordance with an embodiment. As noted above, the open transactions that are executed may involve different cryptocurrencies. A cryptocurrency is a currency that has a ledger that is stored in a decentralized blockchain or distributed ledger. The blockchain records transactions that have occurred using the cryptocurrency in one or more blockchain units stored in the blockchain, but does not require a central authority to verify that the transactions are legitimate. Instead, the blockchain is generated via the cooperation of multiple nodes, or computing systems.

The distributed blockchain network may include a plurality of nodes. Each node is a user or a server that participates in the blockchain network. In a completely public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a cryptographic private key that is used to sign transactions and prove the ownership of a blockchain unit.

The ownership of a blockchain unit may be traced through a chain of transactions. In FIG. 12, a chain of transactions may include a first transaction 1210, a second transaction 1220, and a third transaction 1230, etc. Each of the transactions in the chain may have a fairly similar structure. While each transaction is linked to a prior transaction in FIG. 12, the transaction does not need to be recorded on consecutive blocks on the blockchain. For example, the block recording the transaction 1210 and the block recording the transaction 1220 may be separated by hundreds or even thousands of blocks. The traceback of the prior block is tracked by the hash of the prior block that is recorded by the current block.

Referring to one of the transactions in FIG. 12, for illustration, the transaction 1220 may be referred to as a current transaction. Transaction 1210 may be a prior transaction and transaction 1230 may be referred to a subsequent transaction. Each transaction includes a transaction data 1222, a recipient address 1224, a hash of the prior transaction 1226, and the current transaction's owner's digital signature 1228. The transaction data 1222 records the substance of the current transaction 1220. For example, the transaction data 1222 may specify a transfer of a quantity of a blockchain unit (e.g., an electronic coin, a blockchain token, a BCDR, etc.). In some embodiments, the transaction data 1222 may include code instructions of a smart contract.

The recipient address 1224 is a version of the public key that corresponds to the private key of the digital wallet of the recipient. In one embodiment, the recipient address 1224 is the public key itself. In another embodiment, the recipient address 1224 an encoded version of the public key through one or more functions such as some deterministic functions. For example, the generation of the recipient address 1224 from the public key may include hashing the public key, adding a checksum, adding one or more prefixes or suffixes, and encoding the resultant bits. The recipient address 1224 may be a unique identifier of the digital wallet of the recipient on the blockchain.

The hash of the prior transaction 1226 is the hash of the entire transaction data of the prior transaction 1210. Likewise, the hash of the prior transaction 1236 is the hash of the entire transaction data of the transaction 1220. The hashing of the prior transaction 1210 may be performed using a hashing algorithm such as a secure hash algorithm (SHA) or a message digest algorithm (MD). In some embodiments, the owner corresponding to the current transaction 1220 may also use the public key of the owner to generate the hash. The hash of prior transaction 1226 provides a traceback of the prior transaction 1210 and also maintains the data integrity of the prior transaction 1210.

In generating a current transaction 1220, the digital wallet of the current owner of the blockchain unit uses its private key to encrypt the combination of the transaction data 1222, the recipient address 1224, and the hash of prior transaction 1226 to generate the owner's digital signature 1228. To generate the current transaction 1220, the current owner specifies a recipient by including the recipient address 1224 in the digital signature 1228 of the current transaction 1220. The subsequent owner of the blockchain unit is fixed by the recipient address 1224. In other words, the subsequent owner that generates the digital signature 1238 in the subsequent block 1230 is fixed by the recipients address 1224 specified by the current transaction 1220. To verify the validity of the current transaction 1220, any nodes in the blockchain network may trace back to the prior transaction 1210 (by tracing the hash of prior transaction 1226) and locate the recipient address 1214. The recipient address 1214 corresponds to the public key of the digital signature 1228. Hence, the nodes in the blockchain network may use the public key to verify the digital signature 1228.

The transfer of ownership of a blockchain unit may continue by the owner of the blockchain unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the mining process.

FIG. 13 is a block diagram illustrating a connection of multiple blocks in a blockchain, in accordance with an embodiment. Each block of a blockchain, except the very first block which may be referred to as the genesis block, may have a similar structure. The blocks 1250, 1260, and 1270 may each include a hash of the prior block 1252, a nonce 654, and a plurality of transactions (e.g., a first transaction 1256, a second transaction 1258, etc.). Each transaction may have the structure shown in FIG. 12.

A new block may be generated through a mining process. For a public blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may require a certain format in the hash of prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

By way of example, in generating the hash of prior block 1262, a node which participates in the mining process may randomly combine a version of the prior block 1250 with a random nonce (i.e., a random value) to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries a combination with another different random nonce to generate another hash. The process is repeated by different nodes in the blockchain network until one of the nodes find a hash that satisfies the criteria. The nonce that is used to generate the satisfactory hash is the nonce 1264. The node that first generates the satisfactory hash 1262 may also select what transactions that are broadcasted to the blockchain network is to be included in the block 1260. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., a gas) for having the transaction recorded. After the transactions are selected and the data of the block 1260 is fixed, the nodes in the blockchain network repeat the trial and error process to generate the hash of prior block 1272 by trying different nonces.

In some cases different nodes may select different transactions to include in a subsequent blocks, and may compete with each other to find the proper nonce for that set of transactions that has a generated hash that satisfies the criteria. Therefore, there may be a situation where multiple satisfactory hashes are generated for blocks that contain different transactions. This creates a fork in the blockchain. Future blocks may be hashed based on the data in either block of this fork. However, in practice, in order to avoid adding blocks to multiple forks, the nodes may reach consensus by selecting the fork that has the block with an earlier timestamp, or use some other criteria, in order to select the primary fork from which to hash further blocks. In other embodiments, instead of computing a nonce, which may be computationally expensive, the nodes may use other consensus methods, such as proof of stake methods, to determine which fork to follow.

New blocks may be continued to be generated through the mining process. A transaction of a blockchain unit (e.g., an electronic coin, a blockchain token, a BCDR, etc.) is complete when the broadcasted transaction is recorded in a block. In some embodiment, the transaction is considered settled when the transaction is multi-verified. A transaction is multi-verified when there are multiple subsequent blocks generated and linked to the block that records the transaction.

In some embodiments, some of the transactions 1256, 1258, 1266, 1268, 1276, 1278, etc. may include one or more smart contracts. The code instructions of the smart contracts are recorded may be recorded in the block and are often immutable. When conditions are met, the code instructions of the smart contract are triggered. The code instructions may cause a computer (e.g., a virtual machine of the blockchain) to carry out some actions such as generating a blockchain unit and broadcasting a transaction documenting the generation to the blockchain network for recordation.

### Computing Machine Architecture

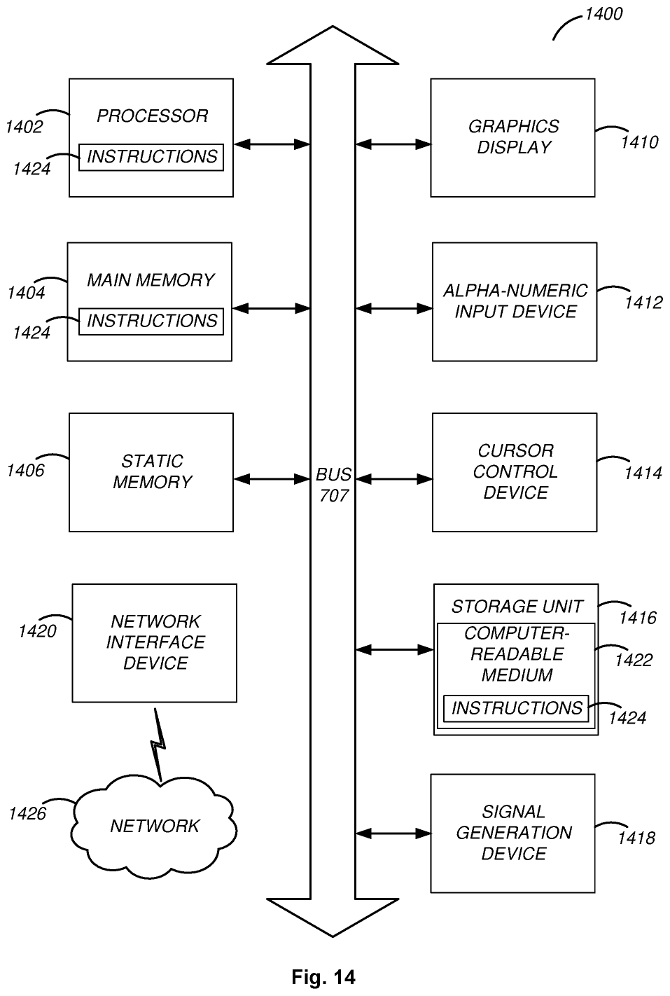

FIG. 14 illustrates a block diagram illustrating components of an example computing machine that is capable of reading instructions from a computer-readable medium and execute them in a processor (or controller). In some embodiments, any one of the transaction router systems 112A-M, third party systems 130A-N, the client device 140, computing device 160 and/or transaction processing exchange system 122 may be in the form of the example computing machine disclosed herein. A computer described herein may include a single computing machine shown in FIG. 14, a virtual machine, a distributed computing system that includes multiples nodes of computing machines shown in FIG. 14, or any other suitable arrangement of computing devices. The computer described herein may be used by any of the elements described in the previous figures to execute the described functions.

By way of example, FIG. 14 shows a diagrammatic representation of a computing machine in the example form of a computer system 1400 within which instructions 1424 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 14 may correspond to any software, hardware, or combined components shown in the above figures. While FIG. 14 shows various hardware and software elements, each of the components described in the above figures may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 1424 that specify actions to be taken by that machine. Further, while only a single machine is illustrated, the term “machine” shall also be taken to include any collection of machines that individually or jointly execute instructions 1424 to perform any one or more of the methodologies discussed herein.

The example computer system 1400 includes one or more processors (generally, processor 1402) (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1404, and a static memory 1406, which are configured to communicate with each other via a bus 708. The computer system 1400 may further include graphics display unit 1410 (e.g., a plasma display panel (PDP), a liquid crystal display (LCD), a projector, or a cathode ray tube (CRT)). The computer system 1400 may also include alphanumeric input device 1412 (e.g., a keyboard), a cursor control device 1414 (e.g., a mouse, a trackball, a joystick, a motion sensor, or other pointing instrument), a storage unit 1416, a signal generation device 1418 (e.g., a speaker), and a network interface device 1420, which also are configured to communicate via the bus 708.

The storage unit 1416 includes a computer-readable medium 1422 on which is stored instructions 1424 embodying any one or more of the methodologies or functions described herein. The instructions 1424 may also reside, completely or at least partially, within the main memory 1404 or within the processor 1402 (e.g., within a processor's cache memory) during execution thereof by the computer system 1400, the main memory 1404 and the processor 1402 also constituting computer-readable media. The instructions 1424 may be transmitted or received over a network 1426 via the network interface device 1420.

While computer-readable medium 1422 is shown in an example embodiment to be a single medium, the term “computer-readable medium” should be taken to include a single medium or multiple media (e.g., a centralized or distributed database, or associated caches and servers) able to store instructions (e.g., instructions 1424). The computer-readable medium may include any medium that is capable of storing instructions (e.g., instructions 1424) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Certain embodiments are described herein as including logic or a number of components, engines, modules, or mechanisms. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 1402, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method of optimizing execution of a transaction request, the method comprising:
retrieving a plurality of timing measurements;
wherein each timing measurement is associated with one of a plurality of transaction router systems and one of a plurality of third party systems, the third party system being in communication with the respective transaction router system;
wherein each timing measurement is indicative of a round trip time (RTT) between the transaction router system and the third party system that are associated with that timing measurement; and
wherein each of the plurality of third party systems has an open transaction liquidity;
determining a plurality of liquidity loss metrics, each liquidity loss metric corresponding to a respective timing measurement, and being associated with the transaction router system and the third party system that are associated with that timing measurement;
wherein each liquidity loss metric is indicative of a proportion of the open transaction liquidity of the third party system associated with the liquidity loss metric that is unavailable to the transaction router system associated with the liquidity loss metric;
determining a plurality of effective remaining liquidity values, each effective remaining liquidity value corresponding to a respective liquidity loss metric, and being associated with the transaction router system and the third party system that are associated with that liquidity loss metric;
wherein each effective remaining liquidity value is indicative of a proportion of the open transaction liquidity of the third party system associated with the effective remaining liquidity value that is available to the transaction router system associated with effective remaining liquidity value;
determining a total effective liquidity value of each transaction router system;
wherein the total effective liquidity value of each transaction router system is determined by summing the effective remaining liquidity values associated with that transaction router system;
determining a plurality of order expiry metrics, each order expiry metric being associated with one of the plurality of transaction router systems, and each order expiry metric being indicative of an average number of transaction requests sent from the relevant transaction router system that fail to execute because of a corresponding open transaction of one of the third party systems in communication with that transaction router system expiring within the relevant RTT;
determining a plurality of slippage metrics, each slippage metric being based on one of the order expiry metrics and being associated with one of the plurality of transaction router systems;
wherein each slippage metric is indicative of a probability that a transaction request sent from the relevant transaction router system will fail to execute because of a corresponding open transaction of one of the third party systems in communication with that transaction router system expiring within the relevant RTT;
determining an optimized transaction router system, that is one of the plurality of transaction router systems, based at least in part on the total effective liquidity values and the slippage metrics; and
sending a received transaction request to the optimized transaction router system, such that the optimized transaction router system can execute the transaction request via one or more of the third party systems, thereby optimizing execution of the transaction request.

2. The computer-implemented method of claim 1, further comprising determining an effective liquidity proportion of each transaction router system;
wherein each effective liquidity proportion is indicative of a ratio between the total effective liquidity value of the respective transaction router system and a total liquidity, the total liquidity being a sum of the open transaction liquidities of each third party system in communication with that transaction router system; and
wherein determining the optimized transaction router system that is one of the plurality of transaction router systems is based at least in part on the effective liquidity proportions and the slippage metrics.

3. The computer-implemented method of claim 1 or claim 2, wherein a linear liquidity loss model relates each timing measurement to the corresponding liquidity loss metric.

4. The computer-implemented method of any one of claims 1 to 3, wherein determining each of the plurality of effective remaining liquidity values comprises calculating the complement of one of the liquidity loss metrics.

5. The computer-implemented method of claims 2 or claim 3 or claim 4 when dependent on claim 2, wherein determining each effective liquidity proportion comprises dividing one of the total effective liquidity values by the total liquidity.

6. The computer-implemented method of any one of claims 1 to 5, further comprising storing an open transaction record history and/or an executed transaction record history, wherein the plurality of order expiry metrics are determined based on an analysis of the open transaction record history and/or the executed transaction record history.

7. The computer-implemented method of any one of claims 1 to 6, wherein determining each order expiry metric comprises:
determining, for each third party system in communication with the relevant transaction router system, a number of transaction requests that fail to execute because of a corresponding open transaction of the relevant third party system expiring within the relevant RTT; and
calculating an average of the numbers.

8. The computer-implemented method of any one of claims 1 to 7, wherein determining each slippage metric comprises:
modelling the slippage metrics according to a Poisson distribution, where a scale parameter (λ) of the Poisson distribution is the order expiry metric associated with the respective transaction router system.

9. The computer-implemented method of any one of claims 1 to 7, wherein determining each slippage metric comprises:
determining order expiry metrics for each of a number of order depths of each transaction router system such that each order depth is associated with a respective order expiry metric;
modelling, for each order depth, a probability that a transaction request sent from the relevant transaction router system will fail to execute because of a corresponding open transaction of one of the third party systems in communication with that transaction router system expiring within the relevant RTT according to a Poisson distribution, where a scale parameter (λ) of the Poisson distribution is the order expiry metric associated with the respective transaction router system; and
determining a probability model value (e^{-λ}) for each order depth.

10. The computer-implemented method of claim 9, further comprising scaling each probability model value according to the order depth with which it corresponds.

11. The computer-implemented method of claim 9 or claim 10, wherein determining each slippage metric comprises summing probability model values corresponding to a respective transaction router system.

12. The computer-implemented method of any one of claims 9 to 11, wherein order expiry metrics are determined for three order depths.

13. The computer-implemented method of claim 1, wherein determining the optimized transaction router system comprises determining the product of the total effective liquidity value and slipping metric associated with each respective transaction router system; wherein the optimized transaction router system is the transaction router system which has the highest product.

14. The computer-implemented method of claim 2, or any one of claims 3 to 12 when dependent on claim 2, wherein determining the optimized transaction router system comprises determining the average of the effective liquidity proportion and slipping metric associated with each respective transaction router system; wherein the optimized transaction router system is the transaction router system that has the highest average.

15. The computer-implemented method of any one of claims 1 to 5, or any one of claims 7 to 14 when dependent on any one of claims 1 to 5, further comprising:
accessing an open transaction record store that comprises a combined list of a plurality of open transactions of the plurality of third party systems;
dividing the received transaction request into one or more split transaction requests based on the open transaction record store; and
sending each of the one or more split transaction requests to a corresponding one of the third party systems.

16. The computer-implemented method of any one of claims 1 to 15, wherein the transaction request comprises a request to exchange a first unit count of a disposed asset for a second unit count of an acquired asset.

17. The computer-implemented method of claim 16, further comprising:
determining, based on the transaction request, the first unit count;
exchanging, at a transaction processing system exchange, a user deposit for the first unit count of the disposed asset;
dividing the first unit count of the disposed asset into two or more split unit counts of the disposed asset; and
transferring control of each of the two or more split unit counts to a respective one of the third party systems, thereby capitalizing a transaction processing system account of each of those third party systems.

18. The computer-implemented method of claim 17, wherein the first asset is a stablefiat cryptocurrency pegged to a fiat currency.

19. A computer-readable storage medium storing instructions that, when executed by a computer, cause the computer to perform the method of any one of claims 1 to 18.

20. A transaction processing system configured to:
retrieve a plurality of timing measurements;
wherein each timing measurement is associated with one of a plurality of transaction router systems and one of a plurality of third party systems, the third party system being in communication with the respective transaction router system;
wherein each timing measurement is indicative of a round trip time (RTT) between the transaction router system and the third party system that are associated with that timing measurement; and
wherein each of the plurality of third party systems has an open transaction liquidity;
determine a plurality of liquidity loss metrics, each liquidity loss metric corresponding to a respective timing measurement, and being associated with the transaction router system and the third party system that are associated with that timing measurement;
wherein each liquidity loss metric is indicative of a proportion of the open transaction liquidity of the third party system associated with the liquidity loss metric that is unavailable to the transaction router system associated with the liquidity loss metric;
determine a plurality of effective remaining liquidity values, each effective remaining liquidity value corresponding to a respective liquidity loss metric, and being associated with the transaction router system and the third party system that are associated with that liquidity loss metric;
wherein each effective remaining liquidity value is indicative of a proportion of the open transaction liquidity of the third party system associated with the effective remaining liquidity value that is available to the transaction router system associated with effective remaining liquidity value;
determine a total effective liquidity value of each transaction router system;
wherein the total effective liquidity value of each transaction router system is determined by summing the effective remaining liquidity values associated with that transaction router system;
determine a plurality of order expiry metrics, each order expiry metric being associated with one of the plurality of transaction router systems, and each order expiry metric being indicative of an average number of transaction requests sent from the relevant transaction router system that fail to execute because of a corresponding open transaction of one of the third party systems in communication with that transaction router system expiring within the relevant RTT;
determine a plurality of slippage metrics, each slippage metric being based on one of the order expiry metrics and being associated with one of the plurality of transaction router systems;
wherein each slippage metric is indicative of a probability that a transaction request sent from the relevant transaction router system will fail to execute because of a corresponding open transaction of one of the third party systems in communication with that transaction router system expiring within the relevant RTT;
determine an optimized transaction router system, that is one of the plurality of transaction router systems, based at least in part on the total effective liquidity values and the slippage metrics; and
send a received transaction request to the optimized transaction router system, such that the optimized transaction router system can execute the transaction request via one or more of the third party systems, thereby optimizing execution of the transaction request.

21. The transaction processing system of claim 20, wherein the transaction processing system is further configured to:
determine an effective liquidity proportion of each transaction router system;
wherein each effective liquidity proportion is indicative of a ratio between the total effective liquidity value of the respective transaction router system and a total liquidity, the total liquidity being a sum of the open transaction liquidities of each third party system in communication with that transaction router system; and
wherein determining the optimized transaction router system that is one of the plurality of transaction router systems is based at least in part on the effective liquidity proportions and the slippage metrics.

22. The transaction processing system of claim 20 or claim 21, wherein one or more of retrieving the plurality of timing measurements, determining the plurality of liquidity loss metrics, determining the plurality of effective remaining liquidity values, determining the total effective liquidity value of each transaction router system, determining the plurality of order expiry metrics determining the plurality of slippage metrics and/or determining the optimized transaction router system is performed by a transaction routing optimizer of the transaction processing system.

23. The transaction processing system of claim 21, wherein determining the effective liquidity proportion of each transaction router system is performed by a transaction routing optimizer of the transaction processing system.

24. The transaction processing system of any one of claims 20 to 23, wherein a linear liquidity loss model relates each timing measurement to the corresponding liquidity loss metric.

25. The transaction processing system of any one of claims 20 to 24, wherein determining each of the plurality of effective remaining liquidity values comprises calculating the complement of one of the liquidity loss metrics.

26. The transaction processing system of claim 22 or any one of claims 23 to 25 when dependent on claim 22, wherein determining each effective liquidity proportion comprises dividing one of the total effective liquidity values by the total liquidity.

27. The transaction processing system of any one of claims 20 to 26, wherein the transaction processing system is configured to store an open transaction record history and/or an executed transaction record history, wherein the plurality of order expiry metrics are determined based on an analysis of the open transaction record history and/or the executed transaction record history.

28. The transaction processing system of any one of claims 1 to 27, wherein determining each order expiry metric comprises:
determining, for each third party system in communication with the relevant transaction router system, a number of transaction requests that fail to execute because of a corresponding open transaction of the relevant third party system expiring within the relevant RTT; and
calculating an average of the numbers.

29. The system of any one of claims 1 to 28, wherein determining each slippage metric comprises:
modelling the slippage metrics according to a Poisson distribution, where a scale parameter (λ) of the Poisson distribution is the order expiry metric associated with the respective transaction router system.

30. The transaction processing system of any one of claims 1 to 29, wherein determining each slippage metric comprises:
determining order expiry metrics for each of a number of order depths of each transaction router system such that each order depth is associated with a respective order expiry metric;
modelling, for each order depth, a probability that a transaction request sent from the relevant transaction router system will fail to execute because of a corresponding open transaction of one of the third party systems in communication with that transaction router system expiring within the relevant RTT according to a Poisson distribution, where a scale parameter (λ) of the Poisson distribution is the order expiry metric associated with the respective transaction router system; and
determining a probability model value (e^{-λ}) for each order depth.

31. The transaction processing system of claim 30, wherein the transaction processing system is configured to scale each probability model value according to the order depth with which it corresponds.

32. The transaction processing system of claim 30 or claim 31, wherein determining each slippage metric comprises summing probability model values corresponding to a respective transaction router system.

33. The transaction processing system of any one of claims 30 to 32, wherein the transaction processing system is configured to determine order expiry metrics for three order depths.

34. The transaction processing system of any one of claims 20 to 33, wherein determining the optimized transaction router system comprises determining the product of the total effective liquidity value and slipping metric associated with each respective transaction router system; wherein the optimized transaction router system is the transaction router system which has the highest product.

35. The transaction processing system of claim 21, or any one of claims 22 to 33 when dependent on claim 21, wherein determining the optimized transaction router system comprises determining the average of the effective liquidity proportion and slipping metric associated with each respective transaction router system; wherein the optimized transaction router system is the transaction router system that has the highest average.

36. The transaction processing system of any one of claims 20 to 26, or any one of claims 28 to 35 when dependent on one of claims 20 to 26, wherein the transaction processing system is further configured to:
access an open transaction record store that comprises a combined list of a plurality of open transactions of the plurality of third party systems;
divide the received transaction request into one or more split transaction requests based on the open transaction record store; and
send each of the one or more split transaction requests to a corresponding one of the third party systems.

37. The transaction processing system of any one of claims 20 to 36, wherein the transaction request comprises a request to exchange a first unit count of a disposed asset for a second unit count of an acquired asset.

38. The transaction processing system of claim 37, wherein the transaction processing system is further configured to:
determine, based on the transaction request, the first unit count;
exchange, at a transaction processing system exchange, a user deposit for the first unit count of the disposed asset;
divide the first unit count of the disposed asset into two or more split unit counts of the disposed asset; and
transfer control of each of the two or more split unit counts to a respective one of the third party systems, thereby capitalizing a transaction processing system account of each of those third party systems.

39. The transaction processing system of claim 28, wherein the first asset is a stablefiat cryptocurrency pegged to a fiat currency.
